(19) United States
(12) Patent Application Publication
(10) Pub. No.: US 2017/0076065 A1
(43) Pub. Date: Mar. 16, 2017

(54) SYSTEM, DEVICE, AND AUTOMATED METHOD FOR VERIFICATION OF MEDICATION INTEGRITY AND CHAIN OF CUSTODY

(71) Applicant: Lynx Rx, Inc., Dallas, TX (US)

(72) Inventors: David B. Darr, Germantown, TN (US); Athanasios D. Agouridis, Dallas, TX (US)

(21) Appl. No.: 15/260,792

(22) Filed: Sep. 9, 2016

Related U.S. Application Data
(60) Provisional application No. 62/216,884, filed on Sep. 10, 2015.

(51) Int. Cl. G06F 19/00; G06K 7/10; G06K 7/14; H04W 4/02

(52) U.S. Cl. CPC G06F 19/3462; H04W 4/02; G06K 7/10366; G06K 7/1413; G06K 7/1417

(57) ABSTRACT

Systems, devices, apparatuses and automated methods are described for tracking and verification of medications and chain of custody. The described technology enables prescription medications and samples to be tracked across supply chains during which the medications and samples may be verified for integrity and proper chain of custody. The described technology also enables prescription medications and samples to be identified by verified location and by unique alphanumeric codes, as well as by secure custodian identifiers, to verify proper tracking and transparent chain of custody. The described technology further provides for secure custody transfers and pedigree assurance for prescription medications and samples.

### CROSS-REFERENCE TO RELATED APPLICATIONS

The instant application claims priority to U.S. Provisional Patent Application No. 62/216,884, entitled “Method, System and Device for Verification of Medication Integrity and Chain of Custody,” filed on Sep. 10, 2015, the entirety of which is incorporated by reference herein.

### BACKGROUND

Technical Field

The present subject matter relates to the tracking and verification of dispensed and/or distributed medications and medication samples.

Background Art

Billions of dollars are associated each year in the United States with dispensed prescription drugs and distributed samples. The lack of supply chain pedigree tracking and tracing across supply chains allows for counterfeiting and diversion of dispensed prescription drugs and distributed samples, e.g., in primary and secondary wholesale markets. Additionally, prescription drug and sample theft is especially problematic, and supply chains are exposed to reentry of these stolen drugs and samples. Sample diversion and theft in clinic office settings pose added challenges as inventory controls are often weak or lacking. Counterfeit off-shore suppliers and individual mail orders pose threats to drug and sample quality and integrity. The number of prosecuted counterfeiters and diversion entities is not indicative of the scope of these problems. The effects of these problems are far-reaching and include patient health and safety impacts, manufacturing revenue and liability impacts, the challenge of identifying and locating recalled products, and federal and commercial insurance fraud and abuse. The severity of these problems is evidenced in the passing of the Drug Quality and Security Act (HR 3204) in November 2013.

### BRIEF SUMMARY

Systems, devices, apparatuses and automated methods are described for tracking and verification of medications and chain of custody, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a portion of a tracking system, according to an example embodiment.

FIG. 2 shows a block diagram of a portion of a tracking system, according to an example embodiment.

FIG. 3 shows a flowchart for tracking, verifying integrity, and verifying custody for prescription pharmaceuticals, according to an example embodiment.

FIG. 4 shows a block diagram of prescription pharmaceutical packaging and labeling, according to an example embodiment.

FIG. 5 shows a block flow diagram of prescription pharmaceutical chain-of-custody, according to an example embodiment.

FIG. 6 shows a block flow diagram for maintaining prescription pharmaceutical chain-of-custody and data flow, according to an example embodiment.

FIG. 7 shows a flowchart for verifying pedigree information for prescription pharmaceuticals, according to an example embodiment.

FIG. 8 shows a flowchart for compliance for prescription medication samples, according to an example embodiment.

FIG. 9 shows a block diagram of a portion of a tracking system with a client device, according to an example embodiment.

FIG. 10 shows a flowchart for transferring custody of prescription pharmaceuticals, according to an example embodiment.

FIG. 11 shows example optical and radio frequency (RF) data for a prescription pharmaceutical label, according to an example embodiment.

FIG. 12 shows a diagram of user interfaces for a client-side devices, according to an example embodiment.

FIG. 13 shows a flowchart for transferring custody of prescription pharmaceuticals, according to an example embodiment.

FIG. 14 shows a portion of a flowchart for transferring custody of prescription pharmaceuticals, according to an example embodiment.

FIG. 15 shows a block diagram of a computing device/system in which the techniques disclosed herein may be performed and the embodiments herein may be utilized.

FIG. 16 shows a block diagram of a mobile device in which the techniques disclosed herein may be performed and the embodiments herein may be utilized.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Numerous exemplary embodiments are now described. Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

### TERMS AND DEFINITIONS

Adherence: Patient administration of the pharmaceutical/medical product as prescribed (e.g., dose, time of day, with/without food, etc.).

Adverse Event: Any event while taking a medication or using a device that is outside of the intended effect of a medication/device.

Adjudication: Validated coverage and payment of a pharmaceutical/medical product by the insurance company and government entities at the time of patient purchase.

Chain of Custody: The documented exchange of product from manufacturer, through the supply chain, and ultimately to the end user (e.g., the patient).

Co-Insurance: A set percentage of the total dollar cost incurred by the patient at the time of purchase of a pharmaceutical product/device.

Copay: A set dollar amount paid by the patient at the time of purchase of a pharmaceutical product/device.

Couponing/Vouchering: Cost offset offering by the manufacturer to a patient to reduce their out of pocket expense of the medication/device.

CRM: Customer Relation Management (software). Used by sales forces to document customer data and sales interactions.

DQSA: Drug Quality and Safety Act of 2013. Standardizes and regulates prescriptions “Track & Trace” throughout the U.S. supply chain.

EMR/EHR: Electronic Medical Records/Electronic Health Records. Provider software used to record/track/reinforce patient care.

Geospatial (global positioning system (GPS) and/or the like): Any system or infrastructure by which the geospatial coordinates can be captured and translated to applicable data including, but not limited to, any satellite-based location tracking system and/or Wi-Fi and wireless hotspot and network node location databases.

GPO: Group Purchasing Organization. An entity that leverages high quantity purchasing to obtain discounts for healthcare providers.

HIPAA: Federal law also known as Health Insurance Portability and Accountability Act of 1996, and associated authorized regulations.

JCAHO: Joint Commission on the Accreditation of Healthcare Organizations. A nonprofit organization that sets standards for quality of patient care.

OCR: Optical Character Recognition. Software that reads alphanumeric text on a physical object, and converts it to data for applicable use.

Optical Read/Optical Data (quick response (QR) code, bar code, and/or the like): A visible code that can be read by a device and translated to applicable data.

PBM: Pharmacy Benefit Manager. A company that handles formulary, adjudication, and mail order pharmacy benefit for a payor (i.e., employer).

PDMA: Federal law also known as Pharmaceutical Drug Marketing Act of 1987, and associated authorized regulations.

Pedigree: Validation of the authenticity and origin of the pharmaceutical/medical product.

Persistency: Patient administration of the pharmaceutical/medical product for the length of time deemed appropriate by the prescriber.

Prescription pharmaceuticals: any type of prescription medicine, prescription medicine sample, and/or the like.

Prior Authorization (PA): Preapproval by insurance or a PBM before a pharmaceutical product/device will be reimbursed.

Radio Frequency (radio-frequency identification (RFID), near-field communication, (NFC), etc.): A code that can be read by a device using radio or other spectrum and translated to applicable data.

Rx: A drug such as a prescribed/prescribable medication or medication sample.

Step Edit: The use of one or more alternate products prior to insurance or a PBM reimbursing for a specific pharmaceutical product/device.

Thermal Sensitive: Any identifier or means of identification that can indicate temperature exposure outside of specified temperature range.

TPA: Third Party Administrator. Handles the pharmacy benefit for a payor (e.g., an employer) in a pass-through expense fashion.

State License Number: An alphanumeric identifier issued by a state associated with a license to prescribe pharmaceutical/medical products/devices.

### Example Embodiments

The described embodiments and techniques may be implemented and utilized in processing devices such as servers and clients, as described herein. For example, systems and devices may be configured in various ways to track and verify integrity and chain of custody for prescription pharmaceuticals, according to the techniques and embodiments provided. It is contemplated herein that in various embodiments and with respect to the illustrated figures of this disclosure, one or more components described and/or shown may not be included and that additional components may be included.

The described embodiments and techniques may be implemented and utilized over networks as described herein, such as computer networks, telephone networks, the Internet, etc. The described embodiments may be configured to be in compliance with federal guidelines and laws for prescription medications and medication samples according to the techniques herein. For instance, by way of example and not limitation, the described tracking, verification, safety and quality, and chain of custody techniques may be performed according to the embodiments herein for prescription medications and medication samples. In embodiments, the provider of the service may utilize a server, including but not limited to, a secure cloud-based server. The server may include segregated logic for HIPAA compliance/auditability, PDMA compliant/auditability, and Joint Commission (JCAHO) complaint/auditability. Additionally, replicated (i.e., redundant) server configurations may be implemented.

The embodiments and techniques herein further advance and support the Food and Drug Administration's (FDSA) Counterfeit Drug Initiative by securing the product and packaging of prescription medications and medication samples, securing supply chain movement, securing business transactions, providing regulatory oversight and enforcement, increasing counterfeit visibility for assessment of penalties, providing heightened vigilance and awareness, and providing international cooperation capabilities.

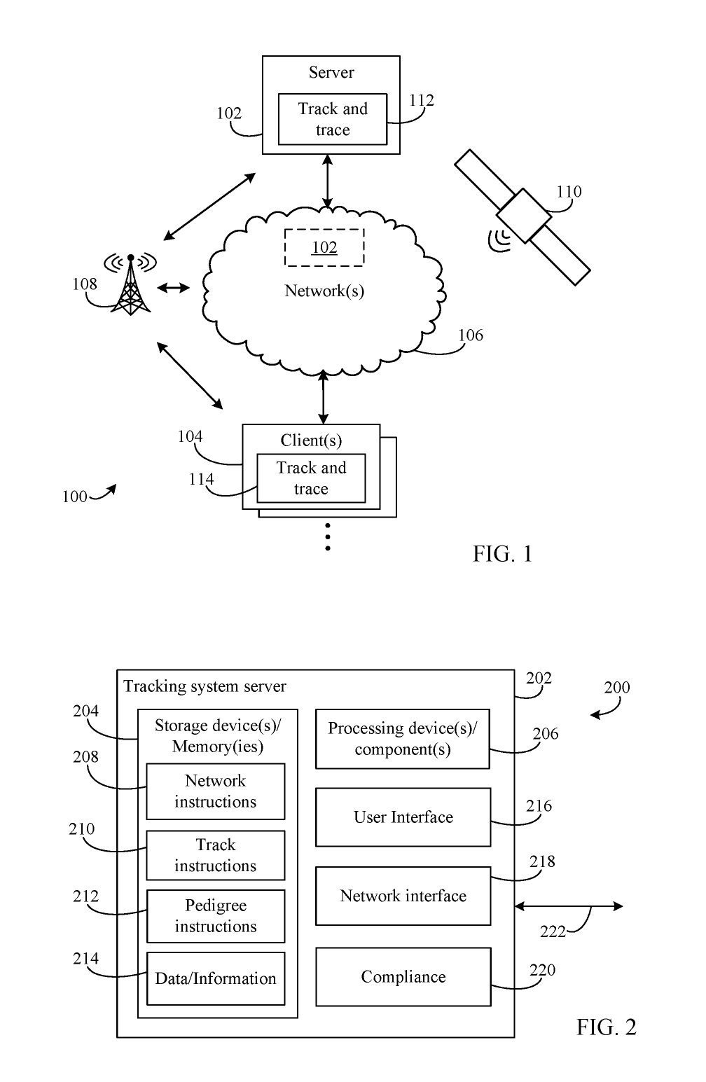

In embodiments, a service provider or provider of a service utilizes a system that hosts network-based servers, cloud-based servers, and/or the like, that communicate with client-side devices (or client devices) over networks, as described herein. For instance, FIG. 1 shows a block diagram of a portion of a tracking system 100, according to an embodiment. Tracking system 100 is configured to track and trace (perform “tracking”) and includes a server 102, a client(s) 104, a computer network 106, and a cellular network 108. Tracking system 100 may also include and/or utilize a location signal provider 110, in embodiments. Tracking system 100 is configured to perform the described tracking, verification, safety and quality, and chain of custody techniques.

Server 102 is configured to be hosted by a provider of the track and trace services described herein. That is, a service provider may employ one or more servers that comprise server 102 to perform the host-side techniques described herein for tracking, verification, safety and quality, and chain of custody for prescription pharmaceuticals, according to embodiments. To this end, server 102 includes a server track and trace component 112 configured to perform the described host-side techniques. According to embodiments, server track and trace component 112 may include one or more circuits, applications, and/or instruction sets for performing the described host-side techniques. Server 102 may be centrally located at the service provider or be hosted by a server hosting service, in embodiments, and is configured to communicate with client(s) 104 over communication network 106 and/or cellular network 108. Further embodiments of server 102 are described below.

Communication network 106 may comprise one or more computer networks (e.g., LANs, WANs, the Internet, etc.) or portions thereof, and may include any number of wireless or wired portions thereof. Server 102 may be a server(s) or distributed server environment (e.g., a networked server(s) or “in the cloud”) within communication network 106, according to embodiments.

Cellular network 108 may comprise one or more telephone and/or cellular data networks (e.g., GSM, LTE, PCS, etc.) or portions thereof. In embodiments, cellular network 108 may be physically and/or conceptually included as part of communication network 106.

Client(s) 104 comprises one or more client devices used by custodians and patients of prescription pharmaceuticals. Server 102 of a service provider may receive information regarding prescription pharmaceuticals as described herein (e.g., unique alphanumeric codes, location, time/date, custodian ID, other prescription pharmaceutical information, etc.) to perform the host-side techniques described herein, according to embodiments. Client track and trace component 114 may include one or more circuits, applications, and/or instruction sets for performing the described client-side techniques, in embodiments. Client(s) 104 are configured to communicate with server 102 over communication network 106 and/or cellular network 108. In various implementations according to embodiments, each custodian and/or patient of prescription pharmaceuticals (e.g., hundreds, thousands, millions, etc.) may utilize a separate, individual client device or client 104 that includes a respective instance of client track and trace component 114 (embodied as various components, instructions, applications, etc., as described herein), and it is contemplated that any number of individual client(s) 104 may concurrently connect to communication network 106 and/or cellular network 108 to be in communication with server 102. Further embodiments of client(s) 104 are described below.

Location signal provider 110 may comprise one or more of GPS signal providers (e.g., GPS satellites, and/or the like) and location based services (LBS) systems that utilize client-side device information, Wi-Fi network information, etc., to determine locations for devices. Locations may be determined in real time, substantially in real time, or upon availability of GPS/LBS signals, in embodiments.

The techniques and embodiments provide for improvements in chain of custody and pedigree assurance using verifiable locations and randomized unique alphanumeric codes for identification of prescription pharmaceuticals. The track and trace embodiments use verified duplication via GPS enabled client devices (e.g., smartphones, tablets, etc.). Embodiments track all activity and applications/instructions wirelessly relay information in real-time. Unique alphanumeric codes comprise independent, random codes providing 62¹⁰ possibilities for each code, or approximately 8.39×10¹⁷ variable codes for each of the optic and RF tags/label described herein.

Systems may include computing devices and/or client devices, such as but not limited to, smart phones and tablets, each of which may include an application(s)/instructions for performing at least a portion of the described techniques, in embodiments. The application(s)/instructions may be provided by a service provider or provider of service that hosts network-based servers, cloud-based servers, and/or the like, as described herein. The application(s)/instructions may include various functionality. For example, an application/instructions may instantly capture information associated with prescription medications and medication samples such as unique alphanumeric codes (e.g., an optical 10 digit alphanumeric code), an RFID from Bluetooth reading devices, passive RFID transmitters, or NFC transmitters, additional optical codes, and or the like, as well as location coordinates. This information may be captured from devices and/or tags affixed to containers, boxes, packages, etc., of the prescription medications and medication samples. The computing devices may be configured to communicate with secure cloud-based servers and utilize ‘read only’ input from an application. The cloud-based servers may include redundancies and multiple server locations. The applications may be designed for ease of use and intuitive operation, and may include a signature line for a receiving party via a secure passcode.

Adverse events reporting features may also be included in applications where alerts and/or information may be sent to manufacturers, to the secure cloud-based servers, and/or to other secure entities. Coupon and voucher options for prescription medications and medication samples may be received by applications from manufacturers or may be generated by applications. Additionally, patient and provider package insert information may be included in, or provided by the applications, e.g., from manufacturers. The applications may also include record distribution options of transactions to all custodial parties to be provided, e.g., via email or other message, access via Internet portal or website, to one or more custodial entities/parties.

Each system, device therein, and/or device user may have a unique ID that may be stored at a/the device (e.g., in association with application/instruction information and/or data), and separate IDs for each installation of an application/instructions on a device are contemplated according to embodiments where separate security logins may be required between separate users of a single device. Applications may utilize device GPS for LBS functionality, or may receive such information or its equivalent from other sources. A user transaction history may be provided within the application and be viewable by a user.

In embodiments, the application(s) may be downloaded to a client device from an application distributor such as Apple, Inc., Google, Inc., Microsoft Corporation, or others such as the service provider. Reader components of devices may be associated with operating systems of such devices, and these devices may include cameras and/or scanners, and/or be geospatially enabled. Optional radio frequency readers (RFID, NFC, and/or the like) may also be included as or in client devices.

In embodiments, custody of prescription medications and medication samples may be transferred utilizing the applications and embodiments/techniques described herein. To transfer custody of prescription medications and medication samples, one or more of the following steps may be performed: scan bottle, box, package, or container for RFID or optic information, use camera to read optical code, use geographic location to confirm approval for sampling, scan thermal sensor or labeling to verify integrity, verify dating for unexpired product distribution, repeat for each stock bottle, box, package, or container of samples/medications, when finished, provide signature line for new custodian, when accepted, former custodian transmits data to the provider of the service, e.g., a host of server 102, and prescriptions appear in new inventory of the custodian(s). In some example embodiments, these operations may not be performed. Moreover, operations in addition to or in lieu of these operations may be performed. Further, in some example embodiments, operations may be performed partially (or completely) concurrently with other operations described herein.

In embodiments, a code such as an identifier (ID) code may be included in physical devices and components such as a label, tag, sensor, and/or the like, and be associated with or affixed to packaging of prescription medications and/or medication samples. ID codes may be utilized such as, without limitation: optic read (QR and/or the like), radio frequency (RF) (RFID, NFC, and/or the like), geospatial (GPS and/or the like), and/or thermal sensitive per product label.

In embodiments, and with respect to medications and samples, ID code information may include, without limitation: unique package serialization alphanumeric codes, unique optic elements, unique radio frequency codes, product names, product strengths, content (i.e. pills/box), lot number/alphanumeric designators, expiration date(s), temperature and storage needs, a manufacturer, and/or a manufacturer plant and location. In embodiments, and with respect to application cloud-based techniques and chain of custody, ID code information may include, without limitation: pharma manufacturing information, pharma warehouse information, a transport vendor, a sales representative, field transfer/reallocation information, a validated health care provider (HCP), a state license number, pharmaceutical company validation process information, and/or PDMA compliance information.

For example, a system or device according to embodiments may be configured to track and trace prescription medications and/or medication samples and verify the safety, quality, and chain of custody thereof. With billions of dollars' worth of prescription medications and/or medication samples in circulation each year (which may translate to millions of prescription medications and/or medication samples), a system such as those described with respect to the techniques and embodiments herein is required for exhaustive tracking and chain of custody verification. Moreover, a label, a tag, a sensor, and/or the like, including combinations thereof, may be affixed to packaging of prescription medications and/or medication samples, and may include unique identifiers as described herein to prevent counterfeiting and enable tracking/chain of custody verification. Similarly, sensors such as heat sensors, allow for verification of proper storage and integrity of prescription medications and/or medication samples where such sensors are located with the prescription medications and/or medication samples to ensure constant compliance. With a combination of labels, tags, and sensors on each prescription medication and/or medication sample package/container, verification of each of the above-noted issues is accomplished.

The described techniques include methods for tracking and tracing of prescription medications or prescription samples, performed in accordance with any of the embodiments described or shown herein.

The methods may further comprise tracking using GPS and/or other geospatial data, optic data, and/or RFID data, tracking using secure alphanumeric codes, tracking using a custodian identification or a recipient identification, tracking using one or more transfer locations of the prescription medications or prescription samples, or tracking using pedigree information related to the prescription medications or prescription samples.

That is, the described techniques and embodiments provide for tracking, verification, safety and quality, and chain of custody for prescription medications and medication samples.

For instance, systems, devices, apparatuses and automated methods are provided for tracking and verification of medications and chain of custody. A method for tracking of prescription pharmaceuticals in accordance with an example aspect is described. The method includes receiving, over a network, data that includes unique alphanumeric codes of two or more tracking tags affixed to a container, and tracking a current location or one or more traversed locations of the prescription pharmaceuticals using tracking information in the data, the tracking data being associated with the unique alphanumeric codes of the two or more tracking tags. The method also includes determining a location validity of the current location or at least one of the one or more traversed locations for the prescription pharmaceuticals, and retrieving pedigree information for the prescription pharmaceuticals based on the unique alphanumeric codes. The method further includes determining a pedigree validity by validating at least a portion of the data against the pedigree information.

A system for tracking of prescription pharmaceuticals in accordance with another example aspect is described. The system includes at least one storage device configured to store computer-readable instructions, and at least one processing device configured to execute the computer-readable instructions. The computer-readable instructions include network instructions, track instructions, and pedigree instructions. The network instructions are executable to receive, over a network from a client device, data that includes unique alphanumeric codes of two or more tracking tags affixed to a container. The track instructions are executable to track a current location or one or more traversed locations of the prescription pharmaceuticals using tracking information in the data, the tracking information being associated with the unique alphanumeric codes of the two or more tracking tags, and determine a location validity of the current location or at least one of the one or more traversed locations for the prescription pharmaceuticals. The pedigree instructions are executable to retrieve pedigree information for the prescription pharmaceuticals based on the unique alphanumeric codes, and determine a pedigree validity by validating at least a portion of the data against the pedigree information.

A method for transferring custody of prescription pharmaceuticals from a first custodian to a second custodian using a third-party tracking service over a network in accordance with another example aspect is also described. The method includes (a) scanning optical information including a first unique alphanumeric code from a first label affixed to a package containing prescription pharmaceuticals using a camera or scanner, and (b) scanning optical or radio frequency identifier (RFID) information including a second unique alphanumeric code from a second label physically associated with the package using the camera or scanner, or using an RFID reader. The method also includes (c) determining geospatial information related to the location of the custody transfer, and (d) generating indicia of identity for the second custodian. The method further includes (e) subsequent to generating the indicia of identity, transmitting over the network, by the first custodian, data that includes the first and second unique alphanumeric codes, the generated indicia, and the geospatial information to the third-party tracking service, and (f) receiving a validation of pedigree information for the prescription pharmaceuticals. Still further, the method includes (g) adding the prescription pharmaceuticals to an inventory of the second custodian. One or more portions of the method may be repeated for changes in custody and/or locations of prescription pharmaceuticals.

Various example embodiments are described in herein. In particular, example server/host embodiments are described. Next, example client embodiments are described. This description is followed by further example advantages and embodiments. Subsequently example computer and mobile device implementations are described. Finally, some concluding remarks are provided. It is noted that any division of the description herein generally into subsections and/or embodiments is provided for ease of illustration, and it is to be understood that any type of embodiment may be described in any subsection.

### Example Server/Host Embodiments

Systems and devices, such as servers and server system portions may be configured in various ways to track and verify integrity and chain of custody for prescription pharmaceuticals, according to the techniques and embodiments provided.

FIG. 2 shows a block diagram of a portion of a tracking system 200, according to an embodiment. Tracking system 200 may be a further embodiment of a portion of tracking system 100 of FIG. 1. Tracking system 200 includes a server 202 and a communication connection 222. Server 202 may be a further embodiment of server 102 of FIG. 1. In embodiments, server 202 is configured to communicate with client devices and/or other server components and/or distributions over one or more networks, as described herein (e.g., cellular network 108 and/or communication network 106), via communication connection 222 which may include wired and/or wireless portions.

In embodiments, e.g., as shown, server 202 is a track and trace (i.e., tracking) server that is part of a tracking system such as tracking system 100 of FIG. 1. Server 202 includes one or more of a storage device/memory 204 (or memory device), one or more processors 206 (e.g., hardware processing devices/components), a user interface 216, a network interface 218, and a compliance component 220. In embodiments, one or more components described and/or shown may not be included for illustrative clarity and/or brevity, and additional components may be included.

User interface (UI) 216 is configured to provide a member of the service provider information stored by server 202, according to embodiments. For example, the member may be an administrator of the service provide and access data/records for patients, custodians, prescription pharmaceuticals, manufacturers, etc., as described herein. UI 216 may be a graphical UI (GUI) according to embodiments. In embodiments, UI 216 is configured to receive user inputs related to administration, management, and maintenance of server 202 and services/functions thereof. UI 216 may be comprised of hardware, software, firmware, or any combination thereof. For example, UI 216 may include a display (e.g., a display screen, a touch screen, etc.), a wired or wireless input device(s) such as a mouse, keyboard, etc., an application on a user device such as a smartphone, tablet, etc., a computer network interface on a laptop or personal computer, and/or audio input/output.

Network interface 218 is configured to allow server 202 to access one or more networks as described herein. Network interface 218 may be comprised of hardware, software, firmware, or any combination thereof. Network interface 218 may comprise wired or wireless components for communication links. Network interface 218 may comprise a hardware processor and memory (not shown) in embodiments.

Storage device/memory 204 may include one or more of hardware storage devices and/or memories as described herein, and may be configured to be communicatively coupled to one or more other components of server 202. Storage device/memory 204 is configured to store network instructions 208, track instructions 210, pedigree instructions 212, and data/information 214, as well as compliance component 220 in some embodiments. In embodiments, one or more of network instructions 208, track instructions 210, pedigree instructions 212, and data/information 214, as well as compliance component 220 may comprise a server track and trace component, as used herein.

Data/information 214 may comprise any information received from a networked device such as a client device (e.g., client(s) 104) or other device on communication network 106 and/or cellular network 108. Data/information 214 may also include information indicative of determinations made by servers, and applications/components/circuits associated therewith, such as server 202 in accordance with the techniques and embodiments herein. Data/information 214 may include information regarding prescription pharmaceuticals that is provided to server 202 by a manufacturer of the prescription pharmaceuticals, such as prescription pharmaceutical names/identifiers, sample or non-sample status, dosage or ingredient information, associations of unique alphanumeric codes to prescription pharmaceutical lots, and/or the like, and may also include pedigree information such as, but not limited to, one or more of a name of a manufacturer, a national drug code (NDC), a lot number, an expiration date, a quantity per unit or package quantities, a product name, a brand name, a generic name, a dosage (e.g., dose quantity and/or strength), one or more storage requirements (including warehousing and transit conditions), and a data input operator identifier. It should be noted that different prescription pharmaceuticals may have pedigree information that is unique or that is different from other prescription pharmaceuticals. For instance, required storage temperatures for one prescription pharmaceutical may differ from required storage temperatures for another prescription pharmaceutical. Data/information 214 may include information regarding prescription pharmaceuticals that is provided to server 202 by an authorized custodian or patient of the prescription pharmaceuticals, including custodian and/or patient IDs, locations, and/or the like.

Compliance component 220 may include circuits, logic, instructions, applications, sub-components, and/or the like, to enable compliance with one or more laws, standards, regulations, etc., for tracking system 200. As noted herein, in embodiments, the provider of the service may utilize a server, including but not limited to, a secure cloud-based server. The server may include segregated logic for HIPAA compliance/auditability, PDMA compliant/auditability, and/or Joint Commission (JCAHO) complaint/auditability. Accordingly, compliance component 220 may include one or more subcomponents configured to achieve such compliance. Additionally, replicated (i.e., redundant) server configurations may be implemented in various configurations.

One or more processors 206 (hereinafter processor(s) 206) may include one or more of hardware processing devices/components as described herein, and may be configured to be communicatively coupled to one or more other components of server 202. Processor(s) 206 is configured to execute computer-readable instructions such as those stored in storage device/memory 204 to perform methods and functions as described.

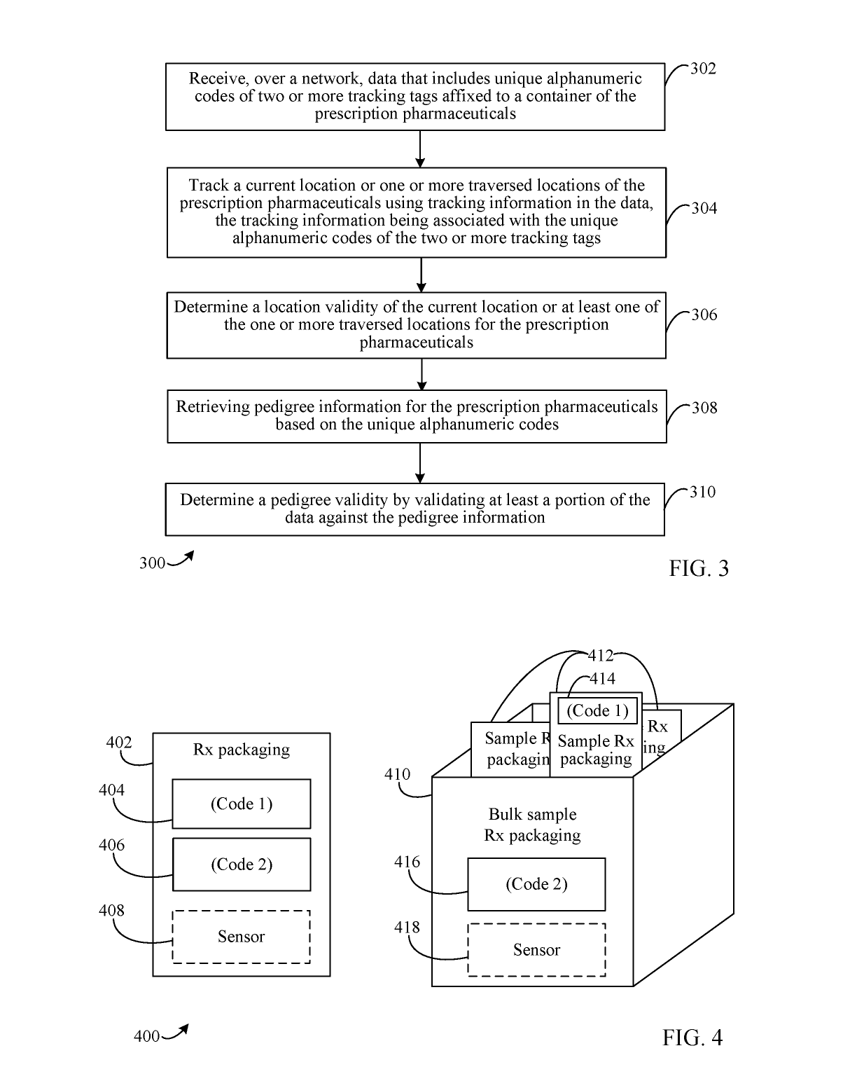

For example, FIG. 3 shows a flowchart 300 for tracking, verifying integrity, and verifying custody for prescription pharmaceuticals, according to an embodiment. Tracking system 100 and tracking system 200, along with any respective components/subcomponents thereof such as server 102 and/or client(s) 104 in FIG. 1 and server 202 in FIG. 2, are configured to perform their respective functions in accordance with flowchart 300, in embodiments. Flowchart 300 is described as follows.

Data that includes unique alphanumeric codes of two or more tracking tags affixed to a container of the prescription pharmaceuticals is received over a network (302). Network instructions 208 are executable to receive, over a network via connection 222 from client devices, data that includes unique alphanumeric codes of two or more tracking tags affixed to a container of the prescription pharmaceuticals, as described with respect to FIG. 4 below. Network instructions 208 may be executable by network interface 218, and may be stored in network interface 218, in embodiments. Referring back to tracking system 100 of FIG. 1, the network may be communication network(s) 106 and/or cellular network 108, and the client devices may be client(s) 104. Network instructions 208 may also be executable to transmit, over the network to the client device, information associated with the location validity and the pedigree validity.

The unique alphanumeric codes may be serialized codes for tracking prescription pharmaceuticals and samples as described herein. The data may also include a product name (brand or generic), a product strength/concentration/dosage, a content type (e.g., pills, box, etc.), a lot number (e.g., as an alphanumeric ID), an expiration date, temperature or storage requirements/needs, product/sample quantity, bulk sample package quantity, a manufacturer, a manufacturer plant and/or location, a packager, etc. In embodiments, the two or more tracking tags affixed to the container of the prescription pharmaceuticals may be read or scanned or the like to obtain the data to be provided to server 202 over the network.

The tracking tags affixed to the container may be affixed as labels or as part of the packaging itself. Turning now to FIG. 4, a block diagram of prescription pharmaceutical packaging and labeling 400 is shown, according to an embodiment. Prescription pharmaceutical packaging and labeling 400 includes a prescription pharmaceutical package 402 and a bulk prescription pharmaceutical sample package 410.

In embodiments, prescription pharmaceutical package 402 may contain a prescription pharmaceutical or a prescription pharmaceutical sample. Prescription pharmaceutical package 402 may have affixed thereto, or as part thereof, a first label 404 and a second label 406. Each of first label 404 and second label 406 may include one or more of optical data (e.g., QR code, bar code, and/or the like) to be captured by a camera or other optical reader, radio frequency data (e.g., an RFID, NFC data, and/or the like) to be captured by a scanner or other RF reader, and/or other scannable/readable data schemes. First label 404 and second label 406 may include different data or identifiers, according to embodiments, and may use the same or different types of data conveyances as outlined above.

Prescription pharmaceutical package 402 may have affixed thereto, or as part thereof, a sensor 408. Sensor 408 may be a thermal sensor, moisture sensor, light sensor, pressure sensor, a timer, etc., that may be related to conditions prescription pharmaceutical package 402 is subjected to during storage or transit. Sensor 408 may be configured to provide a current condition that is sensed (e.g., a current temperature of 80° F.) and/or a peak condition that has been sensed (e.g., a peak temperature of 110° F. was previously reached). Sensor 408 may display sensed information that may be scanned or captured by OCR using a client device cameral/scanner, and/or may transmit information according to any informational conveyance described herein such as optical data (e.g., dynamic QR or barcodes), RFID, NFC, etc. In embodiments, lapse of a timer sensor may indicate expiration of prescription pharmaceuticals.

Bulk prescription pharmaceutical sample package 410 may be a box, bag, bottle, or other container that encapsulates one or more prescription pharmaceutical samples 412. These prescription pharmaceutical samples 412 may be individually packaged, or packaged in quantity per unit packaging. In embodiments, each packaged prescription pharmaceutical sample 412 in bulk prescription pharmaceutical sample package 410 may be similar or identical to each other (with respect to prescription pharmaceutical, manufacturer, dosage, deliver mechanism, etc.). Each packaged prescription pharmaceutical sample 412 in bulk prescription pharmaceutical sample package 410 may include a third label 414, and bulk prescription pharmaceutical sample package 410 may include a fourth label 416. Third label 414 and fourth label 414 may be similarly configured as first label 404 and second label 406 described above, with the exception, in some embodiments, that fourth label 416 may be a single label affixed to bulk prescription pharmaceutical sample package 410 that corresponds to each of packaged prescription pharmaceutical sample 412 contained therein. It should be noted, however, that in some embodiments an additional label (not shown for illustrative clarity) or a duplicate label of fourth label 416 may be affixed to each packaged prescription pharmaceutical sample 412 as similarly shown for prescription pharmaceutical package 402.

Bulk prescription pharmaceutical sample package 410 may have affixed thereto, or as part thereof, a sensor 418. Sensor 418 may be a thermal sensor, moisture sensor, light sensor, pressure sensor, etc., and may be configured the same, or similarly, as sensor 408 described above.

First label 404, second label 406, third label 414, and fourth label 416, along with any other optional labels, may include unique alphanumeric codes for the corresponding prescription pharmaceuticals and/or prescription pharmaceuticals samples as described herein. In embodiments, any of first label 404, second label 406, third label 414, and fourth label 416, along with any other optional labels, as well as sensor 408 and sensor 418, may be included as a part of tracking system 100 of FIG. 1 and/or of tracking system 200 of FIG. 2. Furthermore, while embodying separate, unique codes, labels as described herein may be a part of a single physical label material. Additionally, any sensors described herein may be physically combined with materials for any label(s) in various embodiments. That is, a given physical material that is affixed to prescription pharmaceutical packaging may comprise one or more labels or codes as described herein and/or one or more sensors as described herein.

Referring also now to tracking system 100 of FIG. 1, server 202 of FIG. 2, and flowchart 300 of FIG. 3, a current location or one or more traversed locations of the prescription pharmaceuticals is tracked using tracking information in the data that is associated with the unique alphanumeric codes of the two or more tracking tags (304). For instance, track instructions 210 are executable to track a current location or one or more traversed locations of the prescription pharmaceuticals using tracking information in the data that is associated with the unique alphanumeric codes of the two or more tracking tags. Track instructions 210 may be further executable to track the current location or the one or more traversed locations using at least one of GPS coordinates or other geospatial data associated with the prescription pharmaceuticals.

As described above, information related to the prescription pharmaceuticals is provided in the data (as in (302)) over the network. In embodiments, the data also includes tracking information related to a current location or one or more traversed locations of the prescription pharmaceuticals. That is, prescription pharmaceuticals may physically travel from one entity to another as the prescription pharmaceuticals move from a manufacturer to a patient, and also may move between different physical locations of a single custodial entity. The embodiments and techniques herein provide for location tracking and chain-of-custody of prescription pharmaceuticals between manufacturers and patients.

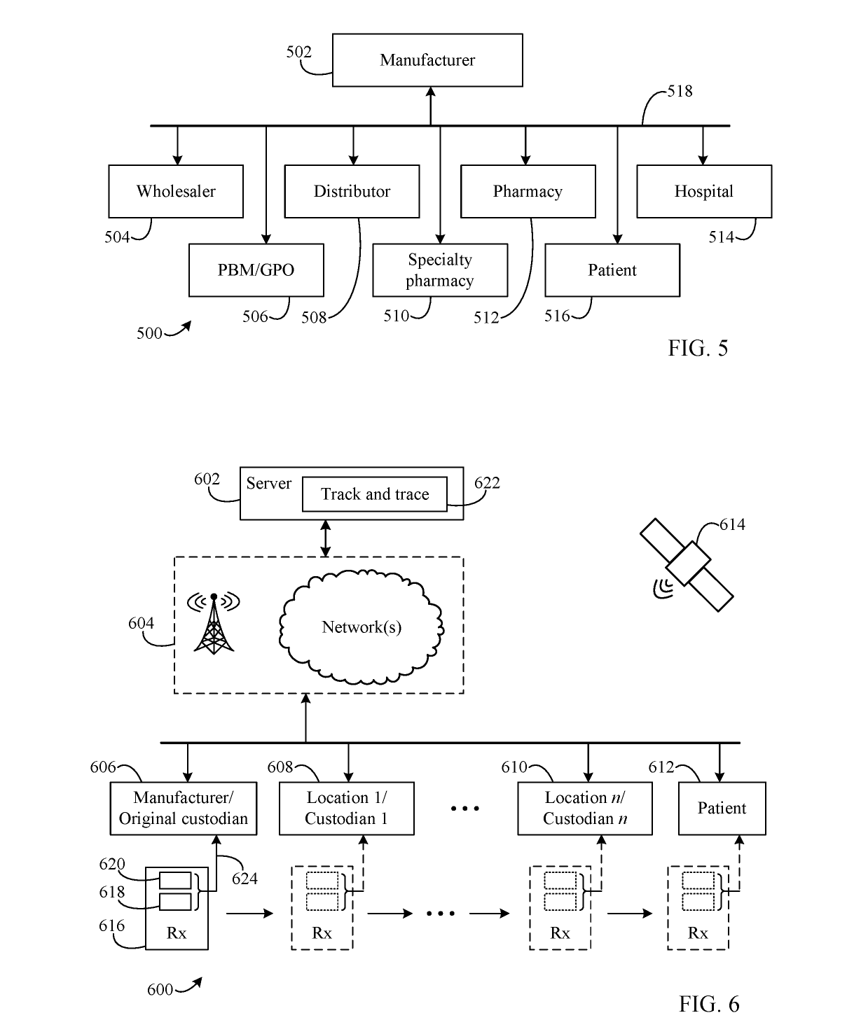

FIG. 5 shows a block flow diagram 500 of prescription pharmaceutical chain-of-custody. For example, prescription pharmaceuticals, including samples, may originate with a manufacturer 502 (including packaging vendors and/or warehousing) and be provided to any of a wholesaler 504 (including sales representatives), a PBM/GPO 506, a distributor 508, a specialty pharmacy 510, a pharmacy 512, a hospital 514 (including clinics and doctor offices), and/or a patient 516 as the prescription pharmaceuticals traverse a chain of supply connections 518 via various custodians. This list of custodial entities is not exhaustive or limiting, and other custodial entities are contemplated herein as would be understood by one of skill in the relevant art(s) having the benefit of this disclosure. Additionally, prescription pharmaceuticals may be provided from any one (or more) of these entities, or custodians of the prescription pharmaceuticals, to any others prior to being delivered to a patient. In the chain of supply represented by chain-of-custody block flow diagram 500, prescription pharmaceuticals may travel by air, ground (e.g., delivery/distributor services), and water (e.g., by ship), between custodians via supply connections 518.

It is also contemplated herein that prescription pharmaceuticals may be transferred backward in the chain of supply, i.e., be returned, in embodiments. For instance, patient 516 may return prescription pharmaceuticals to pharmacy 512 or hospital 514, etc. In such cases, tracking and chain of custody of prescription pharmaceuticals according to the described embodiments is also performed and maintained.

Thus, the embodiments and techniques herein provide for location tracking and chain-of-custody of prescription pharmaceuticals between manufacturers and patients.

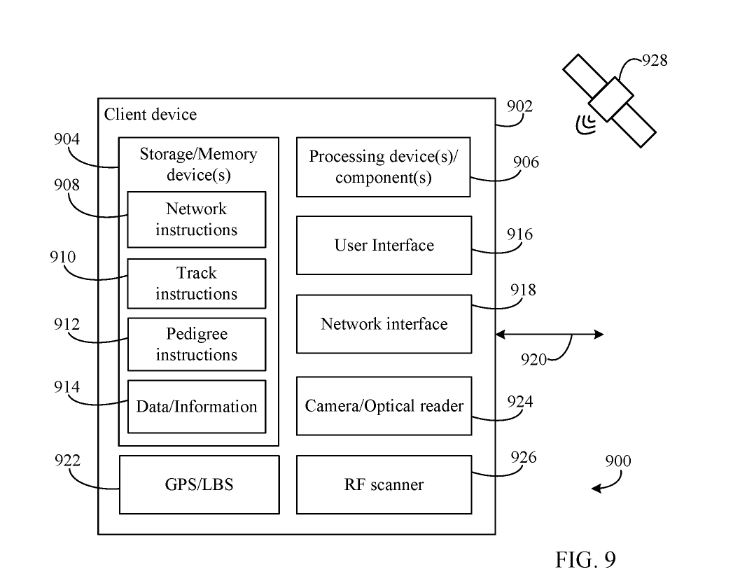

For example, furthering the embodiment described above with respect to FIG. 5, FIG. 6 shows a block flow diagram 600 for maintaining prescription pharmaceutical chain-of-custody and data flow, according to an embodiment. As shown in FIG. 6, information and data may be transmitted and received between a server 602 and client devices (such as client(s) 104 of FIG. 1, and as described in further detail below with respect to FIG. 9) of one or more custodial entities (e.g., a manufacturer 606, a first entity 608, a second entity 610, and a patient 612) over a network 604. While four custodial entities, i.e., manufacturer 606, first entity 608, second entity 610, and patient 612, are shown in FIG. 6 for brevity and illustrative clarity, it should be noted that any number of custodial entities may be included in embodiments, such as those described with respect to FIG. 5. Server 602 may be a further embodiment of server 102 of FIG. 1 and/or server 202 of FIG. 2, and may include a server track and trace component 622 configured to perform host-side techniques for track and trace of prescription pharmaceuticals, as described herein. Moreover, network 604 may be any combination of any portion of communication network 106 and/or cellular network 108. Location signal provider 614 may be a further embodiment of location signal provider 110 of FIG. 1 and may comprise one or more of GPS signal providers (e.g., GPS satellites, and/or the like) and location based services (LBS) systems that utilize client-side device information, Wi-Fi network information, etc., to determine locations for devices/clients of the custodial entities. Locations may be determined in real time, substantially in real time, or upon availability of GPS/LBS signals, in embodiments.

Manufacturer 606 is the original custodian for prescription pharmaceuticals in embodiments where a track and trace process begins. In the context of FIG. 6, an exemplary, non-sample prescription pharmaceutical is discussed, although it is contemplated that the embodiments and techniques fully encompass prescription pharmaceutical samples.

The location of manufacturer 606 is determined when labels of a package for prescription pharmaceuticals, as described above with respect to FIG. 4, are scanned, read, etc. For example, after packaging, a prescription pharmaceutical package 616 has a first label 618 and a second label 620 that may be scanned, read, etc. A custodian of manufacturer 606 may acquire information 624 from first label 618 and second label 620 by scanning or reading the labels using a client device or client, as described herein. With information 624 scanned/read, the prescription pharmaceutical package 616 (and the prescription pharmaceuticals themselves) may be added to an inventory of manufacturer 606. Additionally, information 624 may be provided from manufacturer 606 (e.g., from a client device or client of manufacturer 606), over network 604, to server 602, along with additional information such as custodian identification as described in further detail herein.

At any change of location or custodian/custodial entity, first label 618 and second label 620 of prescription pharmaceutical package 616 may be read/scanned. For instance, when custody of pharmaceutical package 616 is obtained at entity 608 by its custodian from manufacturer 606, information 624 from first label 618 and second label 620 of prescription pharmaceutical package 616 is obtained by the custodian at entity 608 (e.g., by a client or client device of entity 608). Information 624 may again be provided to server 602 (e.g., by a client device or client of entity 608) however this time an ID of the custodian at entity 608 and information associated with entity 608 is provided with information 624 over network 604 to server 602. Prescription pharmaceutical package 616 may be removed from the inventory of manufacturer 606 and may be added to the inventory of the custodian at entity 608.

Likewise, when custody of pharmaceutical package 616 is obtained at entity 610 by its custodian from the custodian of entity 608, information 624 from first label 618 and second label 620 of prescription pharmaceutical package 616 is obtained by the custodian at entity 610 (e.g., by a client device or client of entity 610). Information 624 may again be provided to server 602 (e.g., by a client device or client of entity 610) however this time an ID of the custodian at entity 610 and information associated with entity 610 is provided with information 624 over network 604 to server 602. Prescription pharmaceutical package 616 may then be removed from the inventory of the custodian at entity 608 and be added to the inventory of the custodian at entity 610.

Similarly, patient 612 may scan/read information 624 from first label 618 and second label 620 (e.g., by a client device or client of patient 612) when patient 612 takes custody of prescription pharmaceutical package 616. Prescription pharmaceutical package 616 may be removed from any prior inventories and added to a list of medications of patient 612, and tracking/custodian information may be sent from a client or client device of patient 612 to server 602.

Referring also now to server 202 of FIG. 2 and flowchart 300 of FIG. 3, a location validity of the current location or at least one of the one or more traversed locations is determined for the prescription pharmaceuticals (306). For example, track instructions 210 of server 202 are executable to determine a location validity of the current location or at least one of the one or more traversed locations for the prescription pharmaceuticals. That is, the current or any previous location of the prescription pharmaceuticals may be validated as a legitimate or authorized location. In embodiments, track instructions 210 may compare tracking information in the data for the current location or traversed locations against locations stored in data/information 214 to determine the validity of such locations. In some embodiments, these stored, valid locations may be provided by the manufacturer, or by custodial entities that are trusted by the service provider that implements server 202 (or server 602).

For instance, when custody transfer from manufacturer 606 to the custodian at entity 608 takes place as described above, tracking information such as GPS information or LBS information associated with entity 608 and/or its custodian, as well as with prescription pharmaceutical package 616, is provided to server 602 (e.g., by a client device or client of entity 608). Track and trace component 622 is configured to determine (e.g., via a component or instructions like track instructions 210) if the tracking information provided to server 602 matches a trusted, stored location value for the custodian of entity 608 (and/or for a custodian of a prior holding entity, in this case manufacturer 606) that is also associated with prescription pharmaceuticals in prescription pharmaceutical package 616.

It is contemplated herein that real-time, or substantially real-time transmission of data/information to a server (e.g., server 202, server 602, and/or the like) during a custody change may not be possible due to connectivity issues or availability. In such cases, a client of a custodial entity may be configured to save or queue the data/information desired to be transmitted to the server against the next opportunity for transmission thereof.

Indications of location validity that are determined may be stored by a sever such as server 202 and/or server 602 in a memory or storage device thereof. Such indications may also be provided to clients of custodial entities.

Referring again to flowchart 300 of FIG. 3, pedigree information for the prescription pharmaceuticals is retrieved based on the unique alphanumeric codes (308). For instance, pedigree instructions 212 are executable to retrieve pedigree information for the prescription pharmaceuticals based on the received unique alphanumeric codes. Pedigree information may be a part of data/information 214 of server 202, as described above. That is, for a given type of prescription pharmaceuticals, pedigree information such as, but without limitation, one or more of a name of a manufacturer, an NDC, a lot number, an expiration date, a quantity per unit or package quantities, one or more storage requirements (e.g., enumerated as parameters associated therewith), and data input operator identifiers may be stored by server 202. Unique alphanumeric codes for prescription pharmaceuticals may also be stored by server 202 as a part of data/information 214. When these unique alphanumeric codes for prescription pharmaceuticals are acquired by reading/scanning optical data and provided to server 202, pedigree information associated specifically with the prescription pharmaceuticals is retrieved from data/information 214.

A pedigree validity is determined by validating at least a portion of the data against the pedigree information (310). For example, pedigree instructions 212 may be further executable to determine a pedigree validity by validating at least a portion of the data against the pedigree information. In embodiments, the retrieved pedigree information (from (308)) may be validated against corresponding data received with the unique alphanumeric codes. If the retrieved pedigree information matches the corresponding data, the pedigree information is validated and pedigree validity is determined. If the retrieved pedigree information does not match the corresponding data (excepting an allowed deviation of information), the pedigree information is not validated and pedigree invalidity is determined. As previously noted, different prescription pharmaceuticals may have pedigree information that is unique or that is different from other prescription pharmaceuticals. Accordingly, the described embodiments and techniques allow for retrieval and validation of pedigree information that is specific to a prescription pharmaceutical by linking a given prescription pharmaceutical to appropriate pedigree information via the unique alphanumeric codes. That is, any individual prescription pharmaceuticals package (even for different types of prescription pharmaceuticals with different characteristics, requirements, and manufacturers) that has its unique alphanumeric codes scanned is validated against appropriate pedigree information for that specific type of prescription pharmaceutical.

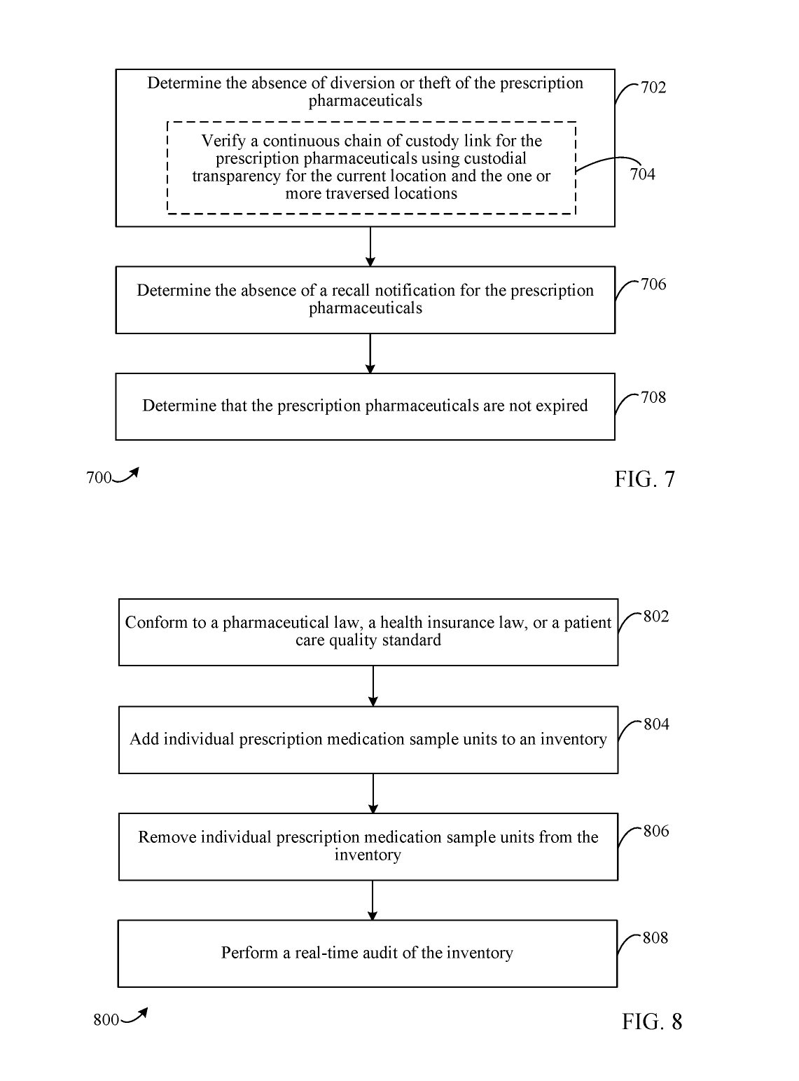

Referring to FIG. 7, a flowchart for verifying pedigree information for prescription pharmaceuticals is shown, according to an embodiment. Referring by example to FIG. 2, pedigree instructions 212 may be further executable to validate at least a portion of data received over the network via connection 222 from a client device against the pedigree information.

For instance, data may be validated by determining the absence of diversion or theft of the prescription pharmaceuticals (702). In some embodiments, this may be performed by verifying a continuous chain of custody link for the prescription pharmaceuticals using custodial transparency for the current location and the one or more traversed locations (704). For instance, track instructions 210 and/or pedigree instructions 212 may be executable to compare each custodial ID and location associated with the movement of a package of prescription pharmaceuticals through a chain of supply against one or more lists of authorized custodial IDs and locations to ensure that each actual custodial ID and location during prescription pharmaceuticals transit is authorized.

Data may be validated by determining the absence of a recall notification for the prescription pharmaceuticals (706). For instance, a manufacturer or authorized agent may provide information related to a recall for prescription pharmaceuticals to be stored in server 202 as part of data/information 214. This recall information may be linked with unique alphanumeric codes associated with prescription pharmaceuticals affected by the recall information. Pedigree instructions 212 may be executable to perform validation at changes of custody and/or location for prescription pharmaceuticals against recall information specific to the prescription pharmaceuticals. An indication of the recall may be provided to a custodian or patient, as described below. In embodiments, such indications may be automatically pushed to custodians or patients upon issues of recalls for prescription pharmaceuticals.

Data may be validated by determining that the prescription pharmaceuticals are not expired (708). For example, when a custody or location change takes place, and one or more unique alphanumeric codes associated with prescription pharmaceuticals are scanned/read, and thus obtained at the time of the change, it may be determined whether or not the prescription pharmaceuticals are expired by performing a pedigree information retrieval based on the obtained unique alphanumeric codes. For instance, a manufacturer or authorized agent may provide information related to expiration of prescription pharmaceuticals to be stored in server 202 as part of data/information 214. This expiration information may be associated with unique alphanumeric codes associated with prescription pharmaceuticals of a certain range of lot numbers and/or manufacturing dates/locations, for example. Pedigree instructions 212 may be executable to perform expiration validations at the changes of custody and/or location for prescription pharmaceuticals. An indication of the expiration or non-expiration may be provided to a custodian or patient, as described below. In embodiments, such indications may be automatically pushed to custodians or patients upon expiration of prescription pharmaceuticals.

It is also contemplated herein that, with respect to a given prescription pharmaceutical, a manufacturer or authorized agent may provide information related to a change in, or an addition/deletion for, pedigree information subsequent to the release of the prescription pharmaceutical. This new/altered prescription pharmaceutical pedigree information may be stored in server 202 as part of data/information 214, and may be linked with unique alphanumeric codes associated with the prescription pharmaceuticals affected. Pedigree instructions 212 may be executable to perform validation at changes of custody and/or location for prescription pharmaceuticals against the new/altered pedigree information specific to the prescription pharmaceuticals. An indication of the change in pedigree information may be provided to a custodian or patient, as described below. In embodiments, such indications may be automatically pushed to custodians or patients upon provision of the new/altered pedigree information by the manufacturer or authorized agent.

The techniques and embodiments herein provide for compliance with institutional and governmental guidelines and federal laws for prescription medications and medication samples. For instance, referring now to FIG. 8, a flowchart 800 for compliance for prescription medication samples is shown, according to an embodiment. Tracking system 100 and tracking system 200, along with any respective components/subcomponents thereof such as server 102 and/or client(s) 104 in FIG. 1 and server 202 in FIG. 2, as well as tracking system 900 and client 902 of FIG. 9, are configured to perform their respective functions in accordance with flowchart 800, in embodiments. Flowchart 800 is described as follows.

Conform to a pharmaceutical law, a health insurance law, or a patient care quality standard (802). The systems and devices described herein are configured to conform to one or more of the disclosed pharmaceutical laws, health insurance laws, and/or a patient care quality standards. That is, the systems and devices described herein are configured to perform their respective functions in accordance with such laws and standards, e.g., as described in flowchart 800.

Individual prescription medication sample units are added to an inventory (804), and individual prescription medication sample units are removed from the inventory (806). For example, using the unique alphanumeric code labeling described herein, individual samples, that may be identical to each other and number in the thousands or millions of units, may be individually added or removed from inventories of manufacturers, custodians, and patients. In embodiments, track instructions 212 may perform inventory removal and additions in data/information 214.

A real-time audit of the inventory is performed (808). For instance, the addition and removal of prescription medication samples utilizing the unique alphanumeric codes in (804/806) allows for real-time inventory audits to be performed on a server (e.g., server 202) by clients as described below.

### Example Client Embodiments

Systems and devices, such as clients or client devices, and portions or components thereof, may be configured in various ways to track and verify integrity and chain of custody for prescription pharmaceuticals, according to the techniques and embodiments provided.

FIG. 9 shows a block diagram of a portion of a tracking system 900 with a client device, according to an embodiment. Tracking system 900 may be a further embodiment of a portion of tracking system 100 of FIG. 1. Tracking system 900 includes a client device 902 and a communication connection 920. Client 902 may be a further embodiment of client(s) 104 of FIG. 1. In embodiments, client 902 is configured to communicate with client devices, servers, and/or other server components and/or distributions over one or more networks, as described herein (e.g., cellular network 108 and/or communication network 106), via communication connection 920 which may include wired and/or wireless portions.

In embodiments, e.g., as shown, client 902 is a track and trace (i.e., tracking) client that is part of a tracking system such as tracking system 100 of FIG. 1. Client 902 includes one or more of a storage device/memory 904 (or memory device), one or more processors 906 (e.g., hardware processing devices/components), a user interface 916, a network interface 918, a geospatial component 922, a camera/optical reader 924, and a radio frequency (RF) scanner 926. In embodiments, one or more components described and/or shown may not be included for illustrative clarity and/or brevity, and additional components may be included. Client 902 may be a client device such as a smartphone, tablet, personal digital assistant (PDA), a wearable processing/communication device, etc., a laptop or personal computer. In embodiments, one or more of the subcomponents of client 902 described herein may not be included, or may be included as a part of client 902 as an attachable device that is attachable either physically or communicatively in a wired or wireless fashion.

User interface (UI) 916 is configured to provide a custodian and/or patient of prescription pharmaceuticals with information regarding prescription pharmaceuticals, such as chain-of-custody, specific prescription pharmaceutical information scanned/read from labels with unique alphanumeric codes, etc., as well as information stored by server 202 that is provided over a network to client 902, according to embodiments. User interface (UI) 916 is configured to accept inputs from a custodian and/or patient of prescription pharmaceuticals regarding information related the prescription pharmaceuticals, such as login credentials for client 902 (e.g., custodial/patient IDs and passwords, including biometric readings via camera/optical reader 924 or a fingerprint scanner (not shown)), specific prescription pharmaceutical information scanned/read from labels with unique alphanumeric codes, etc., according to embodiments. The prescription pharmaceutical custodian may utilize UI 916 to transfer custody of prescription pharmaceuticals to a patient or to another custodian(s). UI 916 may be a graphical UI (GUI) according to embodiments. In embodiments, UI 916 may be comprised of hardware, software, firmware, or any combination thereof. For example, UI 916 may include a display (e.g., a display screen, a touch screen, etc.), a wired or wireless input device(s), an application on the client device (client 902) and/or audio input/output. In embodiments, UI 916 is configured to provide outputs to patients and custodians regarding prescription pharmaceuticals such as pedigree information, chain-of-custody information, location information, etc.

Network interface 918 is configured to allow client 902 to access one or more networks as described herein. Network interface 918 may be comprised of hardware, software, firmware, or any combination thereof. Network interface 918 may comprise wired or wireless components for communication links. Network interface 918 may comprise a hardware processor and memory (not shown) in embodiments.

Storage device/memory 904 may include one or more of hardware storage devices and/or memories as described herein, and may be configured to be communicatively coupled to one or more other components of client 902. Storage device/memory 904 is configured to store network instructions 908, track instructions 910, pedigree instructions 912, and data/information 914. In embodiments, one or more of network instructions 908, track instructions 910, pedigree instructions 912, and data/information 914, may comprise a portion of a client track and trace component, as used herein.

Data/information 914 may comprise any information received from a networked device such as another client device (e.g., client(s) 104 or client 902), a server (e.g., server 102, server 202, server 602), or other device on a network such as communication network 106 and/or cellular network 108. Data/information 914 may also include information indicative of determinations made by client devices and servers, as well as applications/components/circuits associated therewith, in accordance with the techniques and embodiments herein. Data/information 914 may include information regarding prescription pharmaceuticals that is provided to client 902 from a server (e.g., server 102, server 202, server 602), a custodian, and/or a manufacturer of the prescription pharmaceuticals, such as prescription pharmaceutical names/identifiers, sample or non-sample status, dosage or ingredient information, associations of unique alphanumeric codes to prescription pharmaceutical lots, and/or the like, and may also include pedigree information such as, but not limited to, one or more of a name of a manufacturer, a national drug code (NDC), a lot number, an expiration date, a quantity per unit or package quantities, a product name, a brand name, a generic name, a dosage (e.g., dose quantity and/or strength), one or more storage requirements, and a data input operator identifier. Data/information 914 may include information regarding prescription pharmaceuticals that is provided to client 902 by an authorized custodian and/or by a patient of the prescription pharmaceuticals, including custodian and/or patient IDs, locations, and/or the like.

Geospatial component 922 may include logic or applications for LBS, and/or a GPS receiver to receive GPS signals from a signal provider. In embodiments where client 902 is a smartphone, a tablet, a laptop, etc., a geospatial component 922 existing within the client device may be used for determining locations. A location signal provider 928 may be included in tracking system 900 and may be a further embodiment of location signal provider 110 of FIG. 1 and/or location signal provider 614 of FIG. 6.

Camera/optical reader 924 is configured to capture optical data such as from QR codes, barcodes, a face of a patient/custodian, and/or the like. In embodiments where client 902 is a smartphone, a tablet, a laptop, etc., a camera/optical reader 924 existing within the client device may be used for reading and acquiring optical information/data.

Radio frequency (RF) scanner 926 is configured to read radio frequency data such as RFID, NFC, etc. In embodiments where client 902 is a smartphone, a tablet, a laptop, etc., an RF scanner 926 existing within the client device may be used for scanning and acquiring radio frequency data.

One or more processors 906 (hereinafter processor(s) 906) may include one or more of hardware processing devices/components as described herein, and may be configured to be communicatively coupled to one or more other components of client 902. Processor(s) 906 is configured to execute computer-readable instructions such as those stored in storage device/memory 904 to perform client-side methods and functions as described.

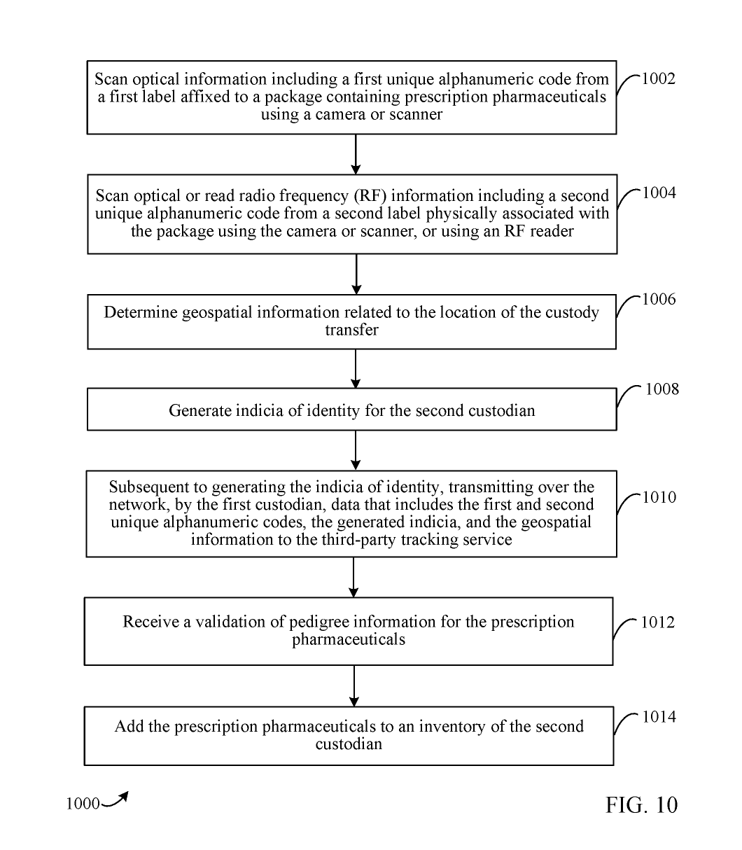

For example, FIG. 10 shows a flowchart 1000 for transferring custody of prescription pharmaceuticals from a first custodian to a second custodian, according to an embodiment. Tracking system 100 and tracking system 900, along with any respective components/subcomponents thereof such as server 102 and/or client(s) 104 in FIG. 1 and client 902 (along with UI 916) in FIG. 9, are configured to perform their respective functions in accordance with flowchart 1000, in embodiments. Flowchart 1000 is described as follows.

Optical information including a first unique alphanumeric code is scanned from a first label affixed to a package containing prescription pharmaceuticals using a camera or scanner (1002). For instance cameral/optical reader 924 of client 902 is configured to capture optical information from a first packing label that includes a first unique alphanumeric code. The optical information that includes the first unique alphanumeric code may be a QR code or a barcode or the like. This optical information is converted to an appropriate format for storage, e.g., as part of data/information 914 in storage device/memory 904, to be used by one or more of network instructions 908, track instructions 910, and pedigree instructions 912.

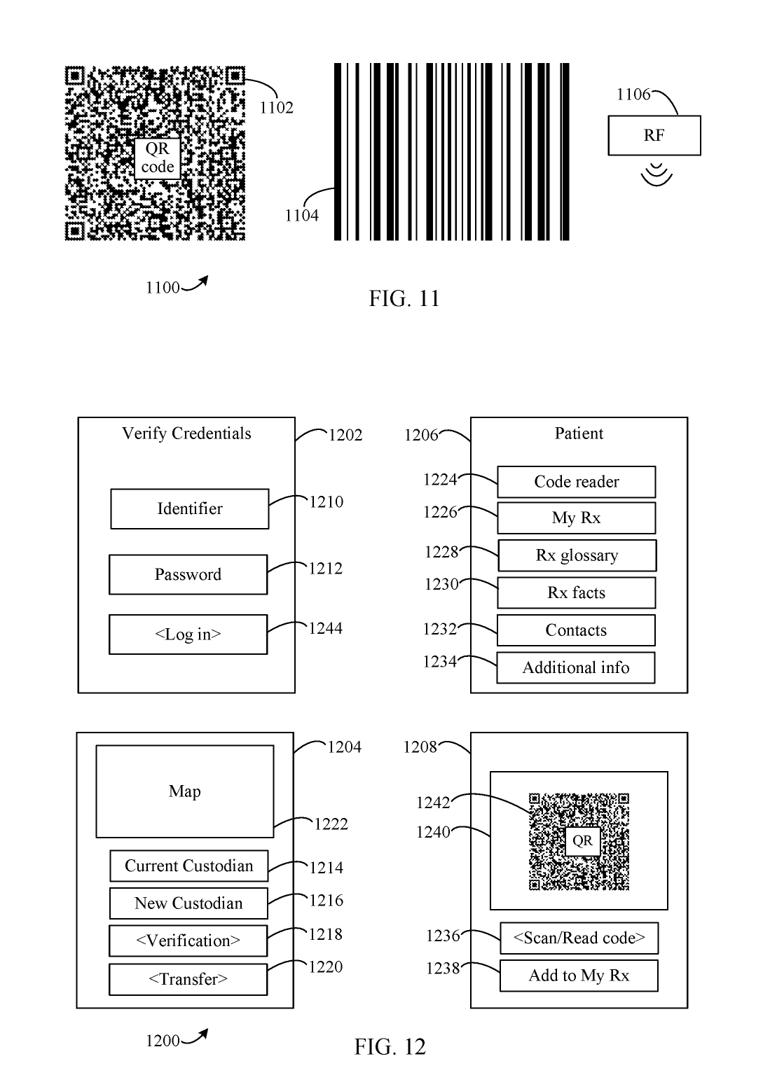

For instance, FIG. 11 shows example optical and RF data/information 1100 for a prescription pharmaceutical label, according to an embodiment. For instance, optical data may include a QR code 1102, according to embodiments. QR code 1102 may include any information related to prescription pharmaceuticals, such as unique alphanumeric codes and information related to prescription pharmaceutical pedigree, and may be printed or otherwise manifested on a label that is to be affixed to a prescription pharmaceuticals package, as described herein. Optical and RF data/information 1100 may include a barcode 1104 in lieu of, or in addition to, QR code 1102. In some embodiments, RF data from an RF transmitter 1106 such as an RFID transmitter or an NFC transmitter may be used in lieu of or in addition to the optical data formats, and is configured to include the same or similar data/information as the optical data/information options. RF data is scanned and captured by RF scanner 926 of client 902. It is also contemplated that other forms of optic codes may be used in lieu of, or in addition to, those exemplarily described herein.

Continuing with flowchart 1000 of FIG. 10, optical or radio frequency (RF) information is scanned or read including a second unique alphanumeric code from a second label physically associated with the package using the camera or scanner, or using an RF reader (1004). Similar to the description in (1002), cameral/optical reader 924 of client 902 is configured to read capture optical information from a first packing label that includes a first unique alphanumeric code, and RF scanner 926 of client 902 is configured to scan and capture RF information. The optical information that includes the second unique alphanumeric code may be a QR code (e.g., QR code 1102), or a barcode (e.g., barcode 1104) or the like, and/or may be an RFID, NFC, or the like (e.g., RF transmissions of RF transmitter 1106). This optical/RF information is converted to an appropriate format for storage, e.g., as part of data/information 914 in storage device/memory 904, to be used by one or more of network instructions 908, track instructions 910, and pedigree instructions 912.

Geospatial information related to the location of the custody transfer is determined (1006). For instance, when transfers of custody or changes of location take place (e.g., such as when the unique alphanumeric codes are scanned/read as in (1002/1004)), as described herein, geospatial component 922 may determine the current location of the prescription pharmaceutical by receiving a signal from location signal provider 928. In embodiments, track instructions 910 may be executable to determine that codes are scanned and to activate geospatial component 922 to determine the current location. If geospatial information is unavailable, a last previously known location or a next determined location may be used in embodiments. The determined geospatial information is converted to an appropriate format for storage, e.g., as part of data/information 914 in storage device/memory 904, to be used by one or more of network instructions 908, track instructions 910, and pedigree instructions 912.

Indicia of identity for the second custodian are generated (1008). For example, pedigree instructions 912 and/or UI 916 may be configured to generate indicia of identity for the second custodian. In embodiments, pedigree instructions 912 may be executable to drive, in whole or in part, the operation of UI 916 for generating these indicia.

Turning now to FIG. 12, a diagram of user interfaces 1200 for a client-side devices is shown, according to an embodiment. A user interface (UI) 1202, a user interface (UI) 1204, a user interface (UI) 1206, and a user interface (UI) 1208 are shown as non-limiting, non-exhaustive examples, and it is contemplated herein that any described client-side processes, methods, or functions and/or any custodial interactions may be realized in user interfaces according to embodiments, as would be understood by one of skill in the relevant art(s) having the benefit of this disclosure. Additionally, more or fewer UI features may be present in alternate embodiments for the described UIs.

UI 1202 is a login UI. For instance, custodians, patients, manufacturers, sales representative, and/or the like, may use a login UI such as UI 1202 to provide credentials for access to the client-side services and/or applications described herein. Credentials may include, without limitation, an identifier 1210 and a password 1212. Identifier 1210 and password 1212 may be assigned or established upon registration of client-side user with a service provider for track and trace of prescription pharmaceuticals. Identifier 1210 may be a government or institution provided identifier, such as a state license number. Valid credentials may be submitted via a log in component 1244. In the context of flowchart 1000, the first custodian may use UI 1202 to log in to client 902 in order to initiate a custody transfer for prescription pharmaceuticals.

The first custodian may then perform the scans/reads of the unique alphanumeric codes as in (1002/1004). UI 1208 is a scan/read UI through which a custodian or patient may scan or read information 1242 (e.g., optic information and/or RF information), as described herein. For instance, a capture window 1240 may provide a preview of an optic information capture, or may show an RF information capture preview as user-viewable data, according to embodiments. Capture component 1236 may be used to capture information 1242, while in some embodiments, capture component 1236 may automatically capture information 1242 when appropriate. One or more codes may be captured using UI 1208.

For patients, prescription pharmaceuticals associated with the captured codes may be added to a patient inventory by selection of add component 1238. This selection may prompt UI 916 to automatically populate with UI 1206 which is a patient information UI. UI 1206 may include a coder reader option 1224 to populate UI 916 with UI 1208, an inventory option 1226 in which to view associated prescription pharmaceuticals, a glossary option 1228 containing relevant prescription pharmaceuticals definitions, a facts option 1230 with one or more facts about relevant prescription pharmaceuticals in the inventory, a contacts option 1232 with contact information for one or more healthcare providers, pharmacies, etc., as well as an additional information option 1234 that may include options such as coupons or discounts, alternate prescription pharmaceuticals, etc.

For custodians, one or more captures of codes may trigger UI 916 to automatically populate with UI 1204 which is a custodian UI. UI 1204 includes a map 1222 that may show a current location or a prior location(s) associated with the prescription pharmaceuticals. UI 1204 also includes a current custodian field 1214 showing the current custodian logged into client 902, a new custodian field 1216, a verification option 1218, and a transfer option 1220.

Referring back to (1008) flowchart 1000, generating indicia of identity for the second custodian may be performed by pedigree instructions 912 and UI 916 (e.g., via UI 1204) by selection of new custodian field 1216. Selection thereof may cause performance of one or more of: automatically populating UI 916 with UI 1202 for entry of credentials, prompting entry of biometric information via camera/optical reader 924 or a fingerprint scanner, and/or prompting audio entry for voice recognition for the second custodian. In embodiments, the entered credentials, biometrics, and/or audio may be converted to a preferred information format/type and saved as the indicia by client 902 in storage device/memory 904.

Subsequent to generating the indicia of identity, data that includes the first and second unique alphanumeric codes, the generated indicia, and the geospatial information is transmitted over the network, by the first custodian, to the third-party tracking service (1010). For instance, network instructions 908 are executable to transmit the first and second unique alphanumeric codes, the generated indicia, and the geospatial information, each being related to the prescription pharmaceuticals, over a network (e.g., communication network(s) 106 and/or cellular network 108, or network 604) from client 902 to a server (e.g., server 102, server 202, server 602) upon activation of verification option 1218 by the first custodian.

A validation of pedigree information for the prescription pharmaceuticals is received (1012). For example, network instructions 908 are executable to receive a validation of pedigree information for the prescription pharmaceuticals. The validation may be received responsive to the transmitting in (1010). The validation may be performed by a track and trace server (e.g., server 102, server 202, server 602) as described herein. The indication of validation (positive or negative) may be displayed by UI 916. If positive, transfer option 1220 may become selectable.

The prescription pharmaceuticals are added to an inventory of the second custodian (1014). For instance, track instructions 910 and/or pedigree instructions 912 may be executable to add the prescription pharmaceuticals to the inventory of the second custodian upon selection of transfer option 1220. In such cases, the prescription pharmaceuticals and associated codes, chain-of-custody/custodian information, location tracking data, pedigree data, etc., may be saved by client 902 of custodian in data/information 914 of storage device/memory 904 and/or by host server of the service provider (e.g., by server 202 in data/information 214 of storage device/memory 204, or the like). Upon adding the prescription pharmaceuticals to the inventory of the second custodian, the prescription pharmaceuticals may be removed from the inventory of the first custodian.

Flowchart 1000, or any portion thereof, may be repeated for any and all transfers of custody and changes of location for prescription pharmaceuticals between a manufacturer and a patient in order to provide full and accurate chain-of-custody, tracking, and pedigree information.

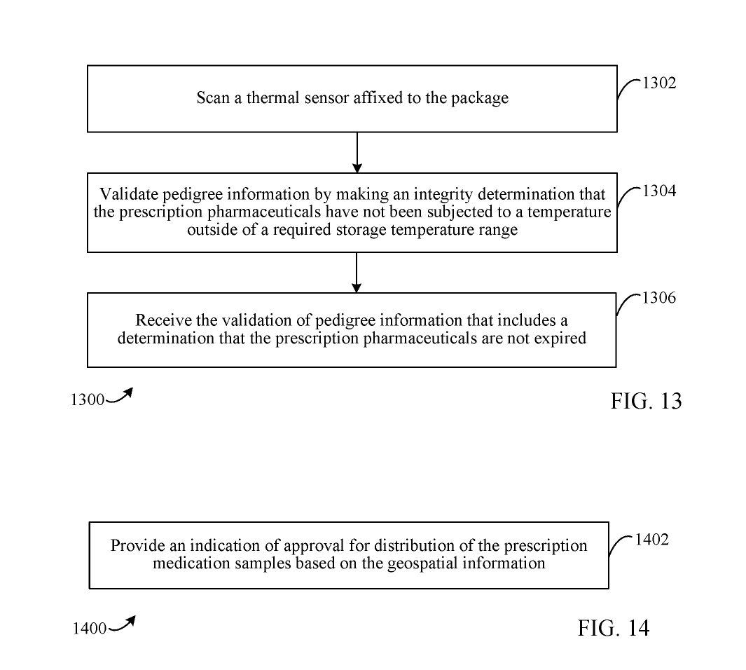

FIG. 13 shows a flowchart 1300 for transferring custody of prescription pharmaceuticals, according to an embodiment. Tracking system 100 and tracking system 900, along with any respective components/subcomponents thereof such as server 102 and/or client(s) 104 in FIG. 1 and client 902 in FIG. 9, are configured to perform their respective functions in accordance with flowchart 1300, in embodiments. Flowchart 1300 is described as follows.

A thermal sensor affixed to the package is scanned (1302). For example, a scanner or reader, as described herein, may obtain thermal information from the thermal sensor. The thermal information may be converted to an appropriate format for storage, e.g., as part of data/information 914, e.g., as pedigree information, in storage device/memory 904, to be used by one or more of network instructions 908, track instructions 910, and pedigree instructions 912. It is contemplated in embodiments that other types of sensors as described herein may also be used in lieu of, or in addition to, thermal sensors.

Pedigree information is validated by making an integrity determination that the prescription pharmaceuticals have not been subjected to a temperature outside of a required storage temperature range (1304). The validation may be based on pedigree information related to the prescription pharmaceuticals (prescription medication samples) by comparing it to the obtained thermal information. The pedigree information may be a portion of data/information 914 stored in storage device/memory 904, or on information related to the prescription pharmaceuticals in data/information 214 stored in storage device/memory 204 of server 202, or the like, in embodiments. In such embodiments, the determination may be provided by the server over a network as described and be received by network interface 918 according to network instructions 908.

Additionally, or alternatively, the validation of pedigree information that includes a determination that the prescription pharmaceuticals are not expired is received (1306). For example, when a custody or location change takes place as described above, and one or more unique alphanumeric codes associated with prescription pharmaceuticals are obtained, it may be determined whether or not the prescription pharmaceuticals are expired by performing a pedigree information retrieval based on the obtained unique alphanumeric codes. This retrieval may be performed by client 902 or by a server, such as server 102, server 202, or server 602. An indication of the expiration or non-expiration may be provided via UI 916 to a custodian or patient.

FIG. 14 shows a portion of a flowchart 1400 for transferring custody of prescription pharmaceuticals, according to an embodiment. Tracking system 100 and tracking system 900, along with any respective components/subcomponents thereof such as server 102 and/or client(s) 104 in FIG. 1 and client 902 in FIG. 9, are configured to perform their respective functions in accordance with flowchart 1400, in embodiments. In the context of flowchart 1400, prescription pharmaceuticals are prescription medication samples. Flowchart 1400 is described as follows.

An indication of approval for distribution of the prescription medication samples is provided based on the geospatial information (1402). For instance, UI 916 of client 902 may provide the indication responsive to a change of custody or location, as described above. The indication may be based on information related to the prescription pharmaceuticals (prescription medication samples) in data/information 914 stored in storage device/memory 904, or on information related to the prescription pharmaceuticals in data/information 214 stored in storage device/memory 204 of server 202, or the like, in embodiments. In such embodiments, the information may be provided by the server over a network as described and be received by network interface 918 according to network instructions 908.

### Further Example Advantages and Embodiments

As noted above, systems and devices may be configured in various ways to perform methods for tracking and verification of medications and chain of custody, according to the techniques and embodiments provided.

In embodiments, one or more of the operations of any flowchart described herein may not be performed. Moreover, operations in addition to or in lieu of any flowchart described herein may be performed. Further, in embodiments, one or more operations of any flowchart described herein may be performed out of order, in an alternate sequence, or partially (or completely) concurrently with each other or with other operations.

A “connector” or “connection,” as used herein, may refer to a hardware connection or a wireless connection for the transfer of data, instructions, and/or information, according to embodiments

The further example embodiments and advantages described in this Section may be applicable to embodiments disclosed in any other Section of this disclosure.

Embodiments and techniques, including methods, described herein may be performed in various ways such as, but not limited to, being implemented in hardware, or hardware combined with one or both of software and firmware.

In accordance with embodiments, the pedigree information may include one or more of a manufacturer name, a national drug code (NDC), a lot number, an expiration date, quantity per unit, a product name, a brand name, a generic name, a dosage (e.g., dose quantity and/or strength), one or more storage requirements, and data input operator ID. The tracking of prescription medications or prescription samples may comprise tracking with respect to one or more of a manufacturer, a wholesaler, a distributor, a hospital, a clinic, a transportation provider, a pharmacy, a specialty pharmacy, and a PBM or GPO. Additionally, embodiments may further comprise verifying one or more aspects of integrity of the prescription medications or prescription samples base on the tracking. The verifying may be based on one or more of track and trace information, a just in time inventory, a recall notification, diversion and theft, product expiration dating, and actual prescription medication or prescription sample storage information. Actual storage information may comprise information from a thermal (or other) sensor associated with or affixed to the prescription medications or prescription samples.

Embodiments include performing verification of pedigree according to one or more of a continuous custody link, custodial transparency, a theft deterrent, a counterfeit deterrent, a re-importation deterrent, and 340b tracking. Embodiments include performing the verification according to one or more inventory control that include a track and trace control, a just in time inventory, a recall notification, and/or product expiration dating.

Embodiments include allowing for real-time or substantially real-time performance of functions such as auditability, adding/removing items from inventories, location tracking, pedigree verification, etc. In some cases near-real-time performance may be utilized when absence of sufficient infrastructure or signals impedes real-time functionality. In such cases, data may be queued/stored/buffered for the next available opportunity to perform a given function.

Embodiments include medication sample compliance using at least one of unique serialized sample units, expiration date clearance, GPS address confirmation, and lot number registration.

The described techniques include embodiments for transferring custody of prescription medications or medication samples. The method may comprises one or more of scanning a bottle, box, package, or container for RFID or optic information, and using a camera to read optical code, using geographic location to confirm approval for sampling, scanning a thermal sensor or labeling to verify integrity, and verifying dating for unexpired product distribution. In accordance with embodiments, repeating one or more of the above operations for each bottle, box, package, or container of medications may be performed.

In embodiments, devices or systems may be configured to perform one or more of the methods described herein. The devices may be processing devices, and the systems may comprise groups of one or more interconnected devices and/or network components.

Further embodiments include, by way of example and not limitation, thermal sensitive labeling, RF ink label capability, tamper resistant labeling, temperature resistant labeling, moisture resistant labeling, add-on features/programs via links that communicate to the internet such as those related to direct to consumer aspects (adherence, persistency, safety, cost offsets, etc.) and compliance enhancements (current and future), and/or the like.

Embodiments described herein, further systems and devices, sub-systems, and/or components disclosed herein may be implemented in hardware (e.g., hardware logic/electrical circuitry), or any combination of hardware with software (computer program code or instructions configured to be executed in one or more processors or processing devices) and/or firmware. With respect to the example computer implementations in this Section, a processing device may be embodied in a smart phone, a smart watch, a tablet, a laptop computer, a desktop computer, a personal digital assistant (PDA), a server, and/or the like.

Further application/instruction embodiments include applications/instructions as follows.

Manufacturer (pharmaceutical company) applications/instructions for samples include passcode security that is company controlled with unique identifiers for each company user/member. Data encryption and secured cloud access are provided, as well as PDMA compliance (e.g., allow/disallow dispensing) and tracking of sample inventories and distributions. Also included are validated transfers to HCPs, geospatial validation of HCP addresses, prescription pharmaceutical expiration date validation, and near-zero inventory errors. Server host (i.e., service provider) auditability is provided, and product pedigree and chain of custody are enabled and provided. Customer sampling access is also allowed for JCAHO compliance.

Optionally provided, in embodiments, are the following features: CRM Integration, adverse event reporting capabilities, patient education (e.g., video, text, links), adherence/persistency/compliance programs, couponing/vouchering programs, linkability to any consumer advertising optical codes, e.g., QR codes or barcodes, advertising impact analyses, non-patient specific, aggregate data, feedback from the service provider, real- and near-real-time sample inventory, notifications of sampling needs, sample rates and patient analyses, as well as other customization.

Manufacturer (pharmaceutical company) applications/instructions for supply chain and custody include passcode security that is company controlled with unique identifiers for each company user/member. Data encryption and secured cloud access are also provided, as well as DQSA compliance that meets/exceeds regulatory requirements, secure drug supply chain with the described “Track & Trace,” a low cost of standardization and implementation, and third party auditability with full transparency. Product liability is minimized (e.g., counterfeit products, ability to recall more specifically, unauthorized re-importation, deterrent to reintroduce stolen product, deterrent to diversion), and reimbursements are ensured via validated pedigree integrity. Also provided are PDMA compliance, server host (i.e., service provider) auditability, product pedigree and chain of custody assurance, and JCAHO compliance.

Optionally provided, in embodiments, are the following features: the ability to link to existing software systems, adverse event reporting capabilities, patient education, adherence/persistency/compliance programs, couponing/vouchering programs, linkability to consumer advertising QR codes, advertising impact analysis, non-patient specific, aggregate data, feedback from the service provider, EMR integration, and meaningful use, as well as other customizations.

Healthcare provider and custodian applications/instructions may include passcode secured applications/instructions using a state license and name user identifier, a unique identifier for each user, and data encryption & secured cloud. Also included are segregated logic where applicable for HIPAA compliance. Sample inventories are also included: notification of transfer from pharma company representative, cloud-based inventories using state license numbers, JCAHO compliance, a sortable data base of all samples by unique alphanumeric code, patient name/identifier entries, and chain of custody to patient. Server host (i.e., service provider) auditability is provided as are patient specific prescription costs including: OCR (optical character recognition) software of patient prescription benefit card, a link to prescription adjudication software (feed from insurance company, PBM, TPA, etc.), and a patient cost of prescription pharmaceuticals (e.g., copay or coinsurance cost, prior authorization or step edit needed, etc.). Also provided are a link to prescribing information and the ability to aggregate providers for health system visibility (based on permission of provider to aggregate).

Optionally provided, in embodiments, are the following features (with manufacturer activation): adverse event reporting capabilities, patient education, adherence/persistency/compliance programs, couponing/vouchering programs, as well as other customization.

Patient/Caregiver applications/instructions include secure applications/instructions with an optional passcode protection, data encryption and secured cloud access (to HIPAA standards), and visibility to product pedigree and chain of custody. Also provided are patient level product information (video, link and/or text) including dose and administration utilities, information regarding common side effects/precautions, other prescription pharmaceutical specific information needs, and caregiver information. Also provided are set dosing alerts” ‘time to take medication’ alerts, take with/without food alerts, an adherence ‘game-like’ tracker to improve prescription pharmaceuticals compliance, persistency of prescription pharmaceuticals tips, other ‘encouragement’ tools, fill/refill reminders, and feedback to provider EMR for compliance/persistency/adherence.

Optionally provided, in embodiments, are the following features: adherence/persistency/compliance programs, direct couponing/vouchering programs, adverse event reporting, and other customization.

### Example Computer and Mobile Device Implementations

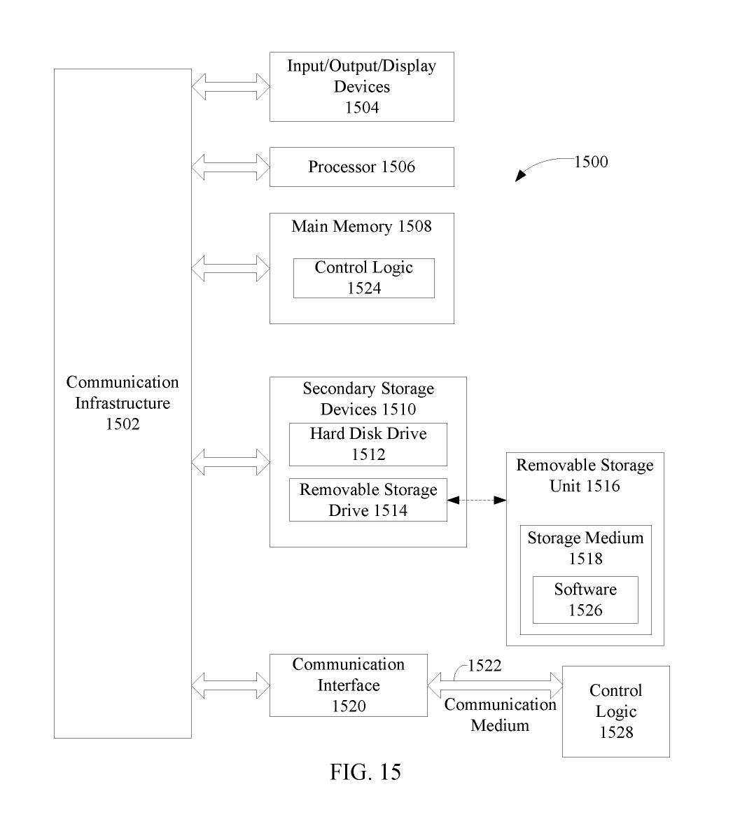

The embodiments described herein, including circuitry, devices, systems, methods/processes, and/or apparatuses, may be implemented in or using well known processing devices, communication systems, servers, and/or, computers, such as a processing device 1500 shown in FIG. 15. It should be noted that processing device 1500 may represent communication devices/systems, entertainment systems/devices, processing devices, and/or traditional computers in one or more embodiments.

Processing device 1500 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Processing device 1500 may be any type of computer, including a desktop computer, a server, etc., and may be a computing device or system within another device or system.

Processing device 1500 includes one or more processors (also called central processing units, or CPUs), such as a processor 1506. Processor 1506 is connected to a communication infrastructure 1502, such as a communication bus. In some embodiments, processor 1506 can simultaneously operate multiple computing threads, and in some embodiments, processor 1506 may comprise one or more processors.

Processing device 1500 also includes a primary or main memory 1508, such as random access memory (RAM). Main memory 1508 has stored therein control logic 1524 (computer software), and data.

Processing device 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, processing device 1500 may include an industry standard interface, such a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer useable or readable storage medium 1518 having stored therein computer software 1526 (control logic) and/or data. Removable storage unit 1516 represents a floppy disk, magnetic tape, compact disk, DVD, optical storage disk, or any other computer data storage device. Removable storage drive 1514 reads from and/or writes to removable storage unit 1516 in a well-known manner.

Processing device 1500 also includes input/output/display devices 1504, such as touchscreens, LED and LCD displays, monitors, keyboards, pointing devices, etc.

Processing device 1500 further includes a communication or network interface 1520. Communication interface 1520 enables processing device 1500 to communicate with remote devices. For example, communication interface 1520 allows processing device 1500 to communicate over communication networks or mediums 1522 (representing a form of a computer useable or readable medium), such as LANs, WANs, the Internet, etc. Network interface 1520 may interface with remote sites or networks via wired or wireless connections.

Control logic 1528 may be transmitted to and from processing device 1500 via the communication medium 1522.

Any apparatus or manufacture comprising a computer useable or readable medium having control logic (software) stored therein is referred to herein as a computer program product or program storage device. This includes, but is not limited to, processing device 1500, main memory 1508, secondary storage devices 1510, and removable storage unit 1516. Such computer program products, having control logic stored therein that, when executed by one or more data processing devices, cause such data processing devices to operate as described herein, represent embodiments. In embodiments, processing device 1500 is configured to implement any of the above-described features of any flowcharts. Computer program logic and/or executable instructions for performing these functions may be stored in any memory of and executed by processor any processor of processing device 1500.

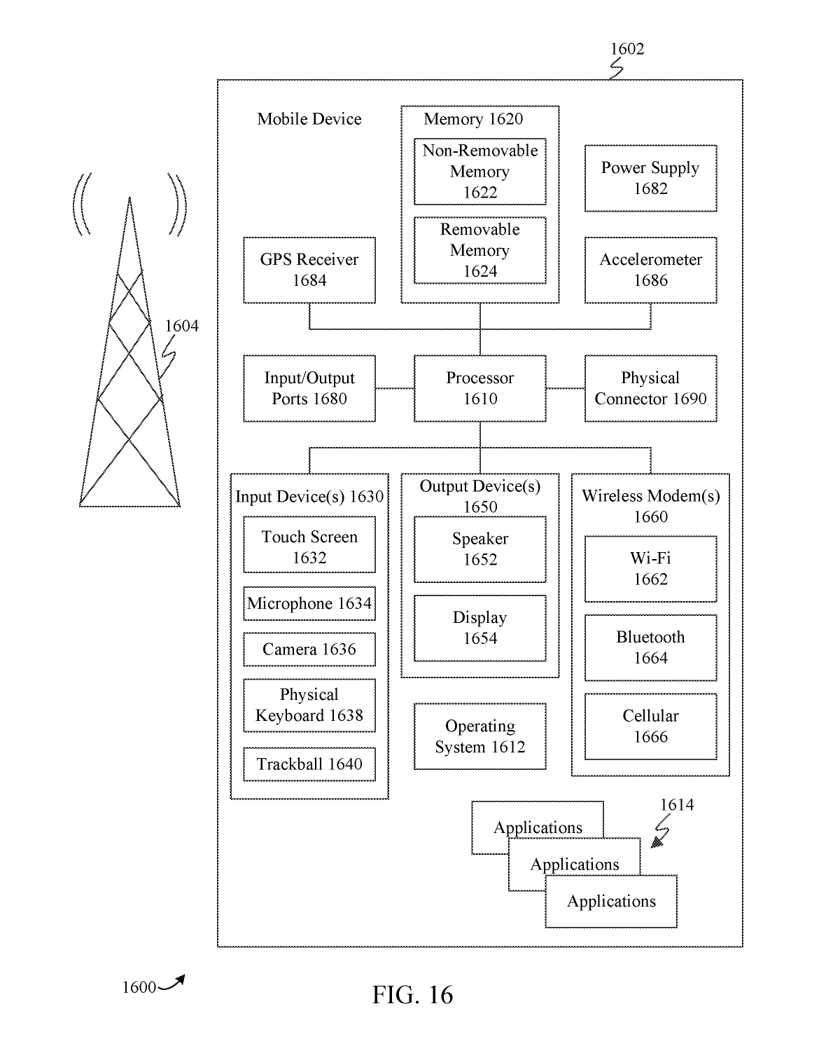

The embodiments described herein, including circuitry, devices, systems, methods/processes, and/or apparatuses, may be implemented in or using well known mobile devices, wearable devices, handheld scanners, and/or, handheld devices, such as a mobile device 1600 shown in FIG. 16. It should be noted that mobile device 1600 may represent personal computing devices/systems, entertainment systems/devices, processing devices, and/or traditional computers in one or more embodiments.

FIG. 16 is a block diagram of an exemplary mobile device 1602 that may implement embodiments described herein. For example, mobile device 1602 may be used to implement client devices such as client(s) 104 of FIG. 1 or computing device 902 of FIG. 9. As shown in FIG. 16, mobile device 1602 includes a variety of optional hardware and software components. Any component in mobile device 1602 can communicate with any other component, although not all connections are shown for ease of illustration. Mobile device 1602 can be any of a variety of computing devices (e.g., cell phone, smart phone, handheld computer, Personal Digital Assistant (PDA), etc.) and can allow wireless two-way communications with one or more mobile communications networks 1604, such as a cellular or satellite network, or with a local area or wide area network.

Mobile device 1602 can include a controller or processor 1610 (e.g., signal processor, microprocessor, ASIC, or other control and processing logic circuitry) for performing such tasks as signal coding, data processing, input/output processing, power control, and/or other functions. An operating system 1612 can control the allocation and usage of the components of mobile device 1602 and provide support for one or more application programs 1614 (also referred to as “applications” or “apps”). Application programs 1614 may include common mobile computing applications (e.g., e-mail applications, calendars, contact managers, web browsers, messaging applications) and any other computing applications (e.g., word processing applications, mapping applications, media player applications).

Mobile device 1602 can include memory 1620. Memory 1620 can include non-removable memory 1622 and/or removable memory 1624. Non-removable memory 1622 can include RAM, ROM, flash memory, a hard disk, or other well-known memory devices or technologies. Removable memory 1624 can include flash memory or a Subscriber Identity Module (SIM) card, which is well known in GSM communication systems, or other well-known memory devices or technologies, such as “smart cards.” Memory 1620 can be used for storing data and/or code for running operating system 1612 and application programs 1614. Example data can include web pages, text, images, sound files, video data, or other data to be sent to and/or received from one or more network servers or other devices via one or more wired or wireless networks. Memory 1620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1602 can support one or more input devices 1630, such as a touch screen 1632, a microphone 1634, a camera 1636, a physical keyboard 1638 and/or a trackball 1640 and one or more output devices 1650, such as a speaker 1652 and a display 1654. Other possible output devices (not shown) can include piezoelectric or other haptic output devices. Some devices can serve more than one input/output function. For example, touch screen 1632 and display 1654 can be combined in a single input/output device. Input devices 1630 can include a Natural User Interface (NUI).

Wireless modem(s) 1660 can be coupled to antenna(s) (not shown) and can support two-way communications between processor 1610 and external devices, as is well understood in the art. Modem(s) 1660 are shown generically and can include a cellular modem 1666 for communicating with the mobile communication network 1604 and/or other radio-based modems (e.g., Bluetooth 1664 and/or Wi-Fi 1662). At least one of wireless modem(s) 1660 is typically configured for communication with one or more cellular networks, such as a GSM network for data and voice communications within a single cellular network, between cellular networks, or between the mobile device and a public switched telephone network (PSTN).

Mobile device 1602 can further include at least one input/output port 1680, a power supply 1682, a satellite navigation system receiver 1684, such as a Global Positioning System (GPS) receiver, an accelerometer 1686, and/or a physical connector 1690, which can be a USB port, IEEE 1394 (FireWire) port, and/or RS-232 port. The illustrated components of mobile device 1602 are not required or all-inclusive, as any components can be deleted and other components can be added as would be recognized by one skilled in the art.

In an embodiment, mobile device 1602 is configured to implement any of the above-described features of any flowcharts. Computer program logic and/or executable instructions for performing these functions may be stored in memory 1620 and executed by processor 1610.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of hardware devices. For instance, embodiments may be included, without limitation, in processing devices (e.g., illustrated in FIGS. 1, 2, 6, 9, 15, and 16) such as computers (clients and servers), as well as communication systems such as switches, routers, gateways, and/or the like, comprising any described networks, communication devices such as smart phones, home electronics, gaming consoles, entertainment devices/systems, etc. A device, as defined herein, is a machine or manufacture as defined by 35 U.S.C. §101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 1506 of FIG. 15 and/or processor 1610 of FIG. 16), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for tracking of prescription pharmaceuticals, comprising:
receiving, over a network, data that includes unique alphanumeric codes of two or more tracking tags affixed to a container of the prescription pharmaceuticals;
tracking a current location or one or more traversed locations of the prescription pharmaceuticals using tracking information in the data, the tracking information being associated with the unique alphanumeric codes of the two or more tracking tags;
determining a location validity of the current location or at least one of the one or more traversed locations for the prescription pharmaceuticals;
retrieving pedigree information for the prescription pharmaceuticals based on the unique alphanumeric codes; and
determining a pedigree validity by validating at least a portion of the data against the pedigree information.

2. The method of claim 1, wherein tracking the current location or the one or more traversed locations includes using at least one of global positioning system (GPS) coordinates or other geospatial data associated with the prescription pharmaceuticals; or
wherein determining the location validity includes using at least one of a custodian identification, a recipient identification, or one or more custody-transfer locations of the prescription pharmaceuticals.

3. The method of claim 1, wherein the pedigree information includes one or more of a manufacturer name, a branded prescription pharmaceutical name, a generic prescription pharmaceutical name, a dosage, a national drug code (NDC), a lot number, an expiration date, a quantity per unit, one or more storage requirements, or a data input operator identifier.

4. The method of claim 1, wherein the unique alphanumeric codes are obtained as at least one of optical data, near-field communication (NFC) data, or radio frequency identifier (RFID) data from one or more labels affixed to packaging of the prescription pharmaceuticals.

5. The method of claim 1, wherein the current location or the one or more traversed locations of the prescription pharmaceuticals are one or more of a manufacturer, a wholesaler, a distributor, a hospital, a clinic, a transportation provider, a pharmacy, a specialty pharmacy, a pharmacy benefit manager (PBM), a group purchasing organization (GPO), and a patient location.

6. The method of claim 1, wherein determining a pedigree validity by validating at least a portion of the data against the pedigree information comprises at least one of:
determining the absence of diversion or theft of the prescription pharmaceuticals;
determining the absence of a recall notification for the prescription pharmaceuticals; or
determining that the prescription pharmaceuticals are not expired.

7. The method of claim 6, wherein determining the absence of diversion or theft comprises verifying a continuous chain of custody link for the prescription pharmaceuticals using custodial transparency for the current location and the one or more traversed locations.

8. The method of claim 1, wherein the prescription pharmaceuticals comprise a plurality of identical prescription medication samples; and
wherein the method further comprises one or more of:
conforming to a pharmaceutical law, a health insurance law, or a patient care quality standard,
adding individual prescription medication sample units to an inventory,
removing individual prescription medication sample units from the inventory, and
performing a real-time audit of the inventory.

9. The method of claim 8, wherein each prescription medication sample is associated with a first code of the unique alphanumeric codes that is obtained as optical data from a label of packaging for each prescription medication sample, and wherein each prescription medication sample is associated with a second code of the unique alphanumeric codes that is obtained as radio frequency data from a label of packaging that encapsulates the packaging for each prescription medication sample.

10. A system for tracking of prescription pharmaceuticals, comprising:
at least one storage device configured to store computer-readable instructions;
at least one processing device configured to execute the computer-readable instructions, the computer-readable instructions comprising:
network instructions executable to receive, over a network from a client device, data that includes unique alphanumeric codes of two or more tracking tags affixed to a container of the prescription pharmaceuticals;
track instructions executable to:
track a current location or one or more traversed locations of the prescription pharmaceuticals using tracking information in the data, the tracking information being associated with the unique alphanumeric codes of the two or more tracking tags; and
determine a location validity of the current location or at least one of the one or more traversed locations for the prescription pharmaceuticals; and
pedigree instructions executable to:
retrieve pedigree information for the prescription pharmaceuticals based on the unique alphanumeric codes; and
determine a pedigree validity by validating at least a portion of the data against the pedigree information.

11. The system of claim 10, wherein the track instructions are further executable to:
track the current location or the one or more traversed locations using at least one of GPS coordinates or other geospatial data associated with the prescription pharmaceuticals; and
determine the location validity using at least one of a custodian identification, a recipient identification, or one or more custody-transfer locations of the prescription pharmaceuticals; and
wherein the network instructions are further configured to transmit, over the network to the client device, information associated with the location validity and the pedigree validity.

12. The system of claim 10, wherein the pedigree information includes one or more of a name of a manufacturer, a branded prescription pharmaceutical name, a generic prescription pharmaceutical name, a dosage, a national drug code (NDC), a lot number, an expiration date, a quantity per unit, one or more storage requirements, and a data input operator identifier; and
wherein the unique alphanumeric codes are obtained as optical data or radio frequency data from one or more labels affixed to packaging of the prescription pharmaceuticals.

13. The system of claim 12, wherein the system further comprises the one or more labels, and
wherein the one or more labels are affixed to the packaging by the manufacturer of the prescription pharmaceuticals or by a packaging or warehousing vendor of the manufacturer.

14. The system of claim 10, wherein the pedigree instructions are further executable to validate the at least a portion of the data against the pedigree information by at least one of:
determining the absence of diversion or theft of the prescription pharmaceuticals by verifying a continuous chain of custody link for the prescription pharmaceuticals using custodial transparency for the current location and the one or more traversed locations;
determining the absence of a recall notification for the prescription pharmaceuticals; or
determining that the prescription pharmaceuticals are not expired.

15. The system of claim 10, wherein the prescription pharmaceuticals comprise a plurality of identical prescription medication samples; and
wherein the computer-readable instructions further comprise inventory instructions executable to:
add individual prescription medication sample units to an inventory,
remove individual prescription medication sample units from the inventory, and
perform a real-time audit of the inventory.

16. The system of claim 15, wherein each prescription medication sample is associated with a first code of the unique alphanumeric codes that is obtained as optical data from a label of packaging for each prescription medication sample, and wherein each prescription medication sample is associated with a second code of the unique alphanumeric codes that is obtained as radio frequency data from a label of packaging that encapsulates the packaging for each prescription medication sample.

17. A method for transferring custody of prescription pharmaceuticals from a first custodian to a second custodian using a third-party tracking service over a network, the method comprising:
(a) scanning optical information including a first unique alphanumeric code from a first label affixed to a package containing prescription pharmaceuticals using a camera or scanner;
(b) scanning optical, or reading radio frequency (RF), information including a second unique alphanumeric code from a second label physically associated with the package using the camera or scanner, or using an RF reader;
(c) determining geospatial information related to the location of the custody transfer;
(d) generating indicia of identity for the second custodian;
(e) subsequent to generating the indicia of identity, transmitting over the network, by the first custodian, data that includes the first and second unique alphanumeric codes, the generated indicia, and the geospatial information to the third-party tracking service;
(f) receiving a validation of pedigree information for the prescription pharmaceuticals; and
(g) adding the prescription pharmaceuticals to an inventory of the second custodian.

18. The method of claim 17, further comprising repeating one or more of (a) through (g) for additional individual units of prescription pharmaceuticals or for additional packages of prescription pharmaceuticals.

19. The method of claim 17, further comprising at least one of:
scanning a thermal sensor affixed to the package, and wherein the validation of pedigree information includes an integrity determination that the prescription pharmaceuticals have not been subjected to a temperature outside of a required storage temperature range; or
receiving the validation of pedigree information that includes a determination that the prescription pharmaceuticals are not expired.

20. The method of claim 17, wherein the prescription pharmaceuticals comprise prescription medication samples; and
wherein the method further comprises:
providing an indication of approval for distribution of the prescription medication samples based on the geospatial information.
